(19) United States
(12) Patent Application Publication
(10) Pub. No.: US 2014/0195377 A1
(43) Pub. Date: Jul. 10, 2014

(54) Combination Retailing System For Appraising Precious Stones And Metals And Dispensing Gift Cards, Coupons And The Like

(71) Applicant: Ward Kraft, Inc., Fort Scott, KS (US)

(72) Inventors: Roger E. Kraft, Fort Scott, KS (US); William R. Russell, Pittsburg, KS (US); Ashly Farmer, Pittsburg, KS (US)

(73) Assignee: Ward Kraft, Inc., Fort Scott, KS (US)

(21) Appl. No.: 14/210,315

(22) Filed: Mar. 13, 2014

Related U.S. Application Data
(63) Continuation-in-part of application No. 13/831,414, filed on Mar. 14, 2013.
Application No. 13/831,414 is a continuation-in-part of application No. 13/245,427, filed on Sep. 26, 2011, now Pat. No. 8,429,021.
Application No. 13/245,427 is a continuation-in-part of application No. 11/901,185, filed on Sep. 14, 2007, now Pat. No. 8,036,951.
(60) Provisional application No. 61/798,339, filed on Mar. 15, 2013.
(60) Provisional application No. 61/532,396, filed on Sep. 8, 2011.

(51) Int. Cl. G06Q 30/06; G06Q 30/02

(52) U.S. Cl. CPC G06Q 30/0609; G06Q 30/0278
USPC 705/26.35

(57) ABSTRACT

A computer implemented method for appraising and selling an item includes the step of using a kiosk to physically receive the item from a seller. The method comprises the step of appraising the item by determining a composition of the item using an evaluating device and associating an exchange value with the item using market data obtained over a network. A global positioning device determines a location of the kiosk. The method includes the step of using a legal database to ascertain a set of rules governing the sale of the item in the location. The set of rules comprise a holding requirement dictating that the item be retained for a fixed number of days before it is sold to a buyer. The method also includes the step of selling the item to the buyer at the kiosk in compliance with the set of rules.

### CROSS-REFERENCE TO RELATED APPLICATIONS

This application claims priority to U.S. Provisional Patent Application Ser. No. 61/798,339, filed Mar. 15, 2013. This application is also a continuation-in-part of U.S. patent application Ser. No. 13/831,414, filed Mar. 14, 2013, which is a continuation of U.S. patent application Ser. No. 13/245,427, filed Sep. 26, 2011, now U.S. Pat. No. 8,429,021, which: (a) is a continuation-in-part of U.S. patent application Ser. No. 11/901,185, filed Sep. 14, 2007, now U.S. Pat. No. 8,036,951; and (b) claims priority to U.S. Provisional Patent Application Ser. No. 61/532,396 filed Sep. 8, 2011. The disclosure of each is incorporated herein by reference in its entirety.

### FIELD OF THE INVENTION

The present invention relates to a combination retailing system that appraises for its users items having precious or semi-precious stones and/or metals. The system may dispense shipping labels to allow users to conveniently ship their precious items to others after the appraisal, and may allow users to trade their items over the internet for one or more of a plurality of preselected products. The system may be configured to hold the items for differing periods of time prior to sale based on the applicable laws of the jurisdiction in which the system is located.

### SUMMARY

Systems and methods for appraising and selling items are disclosed herein. According to one embodiment, a system located in one of a first area and a second area is configured to appraise and retain an item physically received from a seller and to thereafter sell the item to a buyer. The item has at least one constituent selected from the group consisting of a precious stone, a semi-precious stone, a precious metal, and a semi-precious metal. The system comprises a transaction point computer configured to appraise the item. Appraising the item includes determining a composition of the item using an evaluating device and associating an exchange value with the item using data obtained by the evaluating device and market data obtained over a network. The system also comprises a networking device and a legal database for storing a first set of rules and a second set of rules. The first set of rules governs the sale of the item in the first area. The second set of rules governs the sale of the item in the second area. The system includes a global positioning device for determining a location of the system. The computer includes machine readable instructions to ensure that the sale of the item to the buyer is in compliance with the first set of rules when the location is the first area and the second set of rules when the location is the second area.

According to another embodiment, a system located in one of a first area and a second area is configured to appraise and retain an item physically received from a seller and to thereafter sell the item to a buyer. The item has at least one constituent selected from the group consisting of a precious stone, a semi-precious stone, a precious metal, and a semi-precious metal. The system comprises a transaction point computer configured to appraise the item. Appraising the item includes determining a composition of the item using an evaluating device and associating an exchange value with the item using data obtained by the evaluating device and market data obtained over a network. The system also includes a networking device and a legal database for storing a first set of rules and a second set of rules. The first set of rules govern the sale of the item in the first area and the second set of rules govern the sale of the item in the second area. The system has a global positioning device for determining a location of the system, a vault for retaining the item, and a display case for displaying the item. The computer includes machine readable instructions to ensure that the sale of the item to the buyer is in compliance with the first set of rules when the location is the first area and the second set of rules when the location is the second area.

According to yet another embodiment, a computer implemented method for appraising and selling an item includes the step of physically receiving the item from a seller. The item has at least one constituent selected from the group consisting of a precious stone, a semi-precious stone, a precious metal, and a semi-precious metal. The method comprises the step of appraising the item. Appraising the item includes determining a composition of the item using an evaluating device and associating an exchange value with the item using data obtained by the evaluating device and market data obtained over a network. A global positioning device is used to determine a location of the system. The method further comprises the step of using a legal database to ascertain a set of rules governing the sale of the item in the location. The set of rules comprise a holding requirement dictating that the item be retained for a fixed number of days after it is received from the seller and before it is sold to a buyer. The method also includes the step of selling the item to the buyer in compliance with the set of rules.

### BRIEF DESCRIPTION OF THE SEVERAL VIEWS OF THE DRAWINGS

Illustrative embodiments of the present invention are described in detail below with reference to the attached drawing figures and wherein:

FIG. 1 shows a schematic of a retail location, such as a fixed installation store and the like.

FIG. 2 shows a perspective view of a kiosk according to one embodiment of the current invention.

FIG. 3 shows the various elements of the kiosk of FIG. 2 and illustrates electronic communication.

FIGS. 4A and 4B illustrate operation of one portion of the kiosk of FIG. 2.

FIGS. 5 and 6A through 6C illustrate programming in the kiosk of FIG. 2 and methods of using the kiosk of FIG. 2.

FIG. 7 shows various elements of an alternate embodiment of the kiosk of FIG. 2.

FIGS. 8A-8B show flowcharts illustrating methods of using the kiosk of FIG. 7.

FIG. 9 shows a certificate dispensed by the kiosk of FIG. 7.

FIG. 10 shows exemplary contents of a legal database of the kiosk of FIG. 7.

FIG. 11 shows various elements of another alternate embodiment of the kiosk of FIG. 2.

FIG. 12 shows a flowchart illustrating a method of using the kiosk of FIG. 11.

FIGS. 13A and 13B show exemplary contents of a consumer goods database of the kiosk of FIG. 11.

FIGS. 14 through 18 show various views of a fold-under label dispensed by the kiosk of FIG. 11.

FIG. 19 shows the fold-under label of FIG. 14 after it is folded and adhered to a shipping carton.

FIG. 20 shows the fold-under label of FIG. 19 after a tear strip is detached.

FIG. 21 shows the kiosk of FIG. 11 displaying programming and advertising on an output device.

FIG. 22 shows various elements of yet another alternate embodiment of the kiosk of FIG. 2.

FIGS. 23, 24, 25, and 27 show flowcharts illustrating a method of using the kiosk of FIG. 22.

FIG. 26 shows a shipping carton containing a valuable item to be shipped to a depository.

### DETAILED DESCRIPTION

The present invention is directed to a combination retailing system that offers a series of consumer goods, precious or semi-precious stones and metals, and ready to eat convenience food products at a single location. This combination retailing system also provides an avenue for customers to have their precious or semi-precious stones and metals appraised. Customers may utilize the time during which their precious or semi-precious stones and metals are being appraised to enjoy the variety of consumer goods and convenience food products made available by the combination retailing system. After the appraisal, the retailing system provides customers with the opportunity to trade or sell their precious or semi-precious stones and metals.

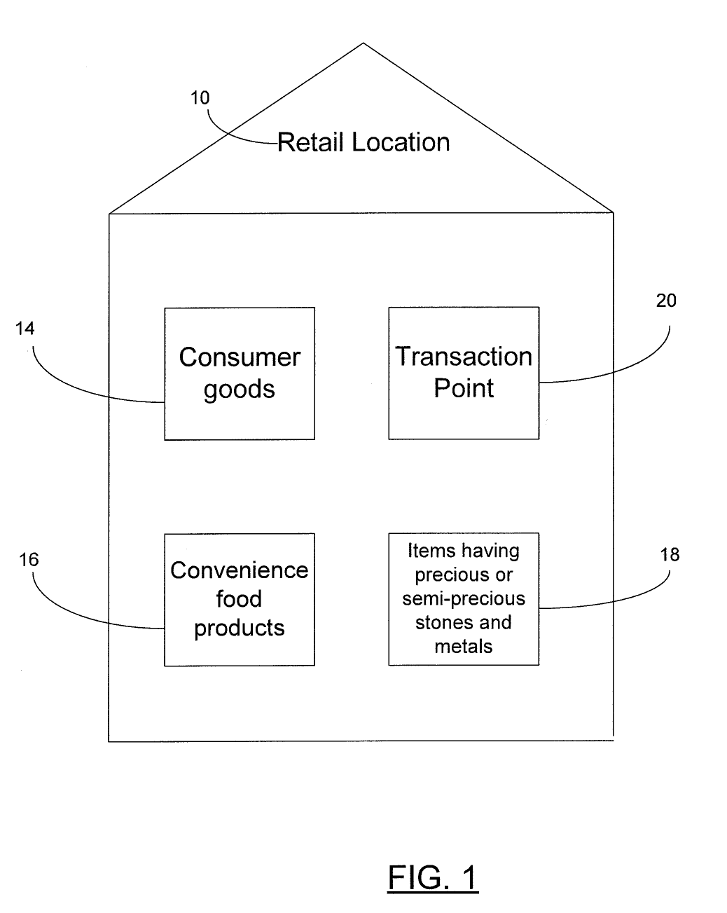

Reference is now directed to FIG. 1, which includes a schematic of a retail location (or “point-of-purchase”) 10. The retail location 10 may carry a variety of consumer goods 14, which may include magazines, newspapers, health and beauty products, household items, seasonal or regional offerings, general retailing merchandize, et cetera, and convenience food products 16, which may include any product commonly consumed as food or drink, such as fast food items, chips, candy, fruit, juices, coffee, tea, organic foods, and the like. The retail location 10 may also carry valuable items 18 that include precious or semi-precious stones and metals, such as diamond necklaces, gold chains, silver bracelets, platinum rings, pearl earrings, bars or coins of gold, silver, or platinum, or a cut or uncut diamond, emerald, pearl, or other gem.

A transaction point 20 may be provided at the retail location 10. The transaction point 20 will be used by the customers to place one or more transactions for the consumer goods 14, convenience food products 16, and valuable items 18 being offered at the retail location 10. The transaction point 20 can include a sales person, a video display, such as a touch screen, computer terminal, telecommunications equipment, such as a telephone or facsimile machine or combinations of any of the foregoing.

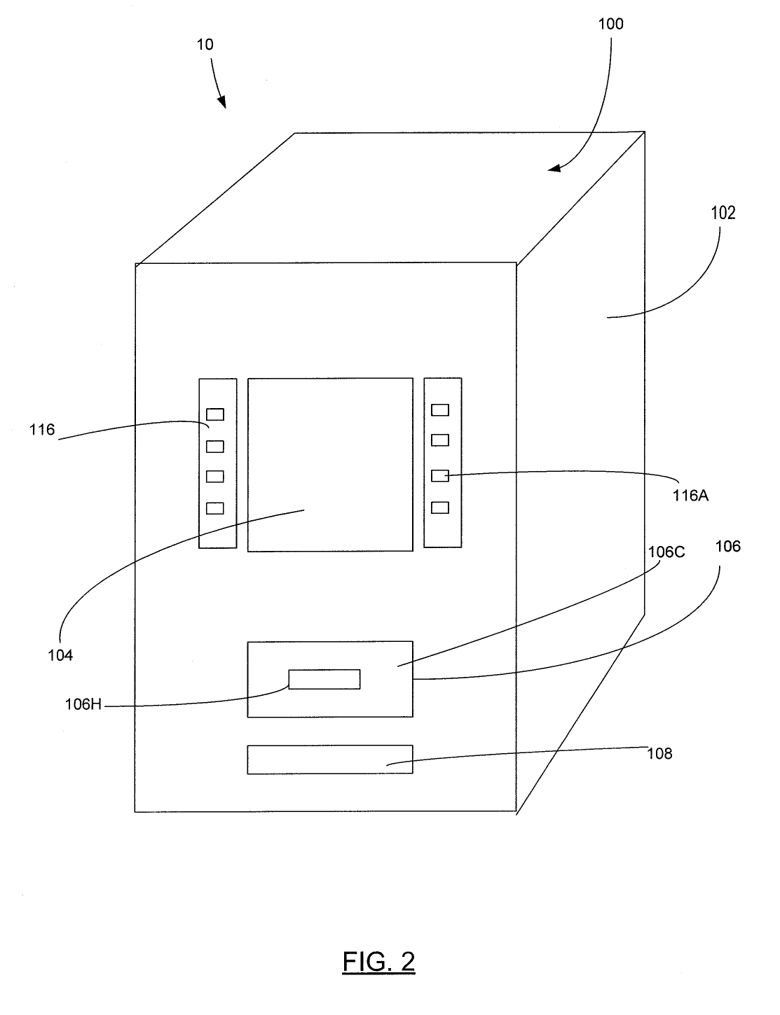

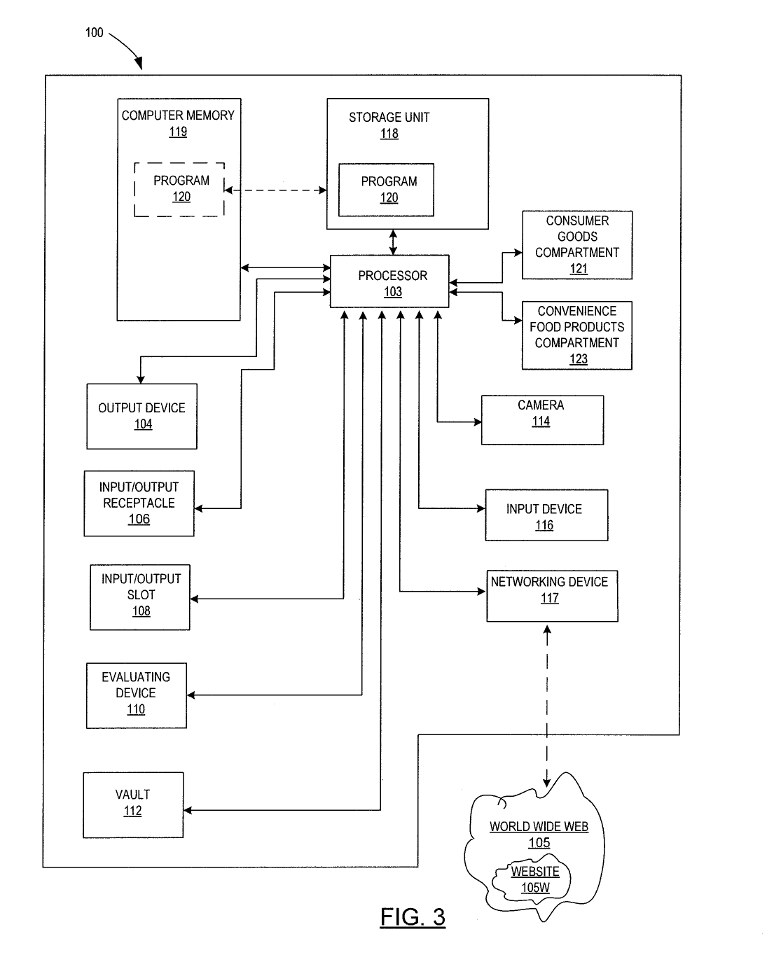

The retail location 10 may be a fixed retail outlet, such as a store in an indoor or outdoor shopping mall or a standalone store, and as shown in FIG. 1, may have a series of walls, a floor, a roof, and other features commonly associated with a store. As shown in FIGS. 2 and 3, the retail location 10 may also comprise a kiosk 100 that can be assembled by or within a larger structure such as a shopping mall or department store and which provides a functional retailing system as described in the embodiments of the present invention. The kiosk 100 may be manually operated, or may be fully or partially automated.

According to one embodiment, the kiosk 100 includes an outer casing (or “housing”) 102 and a processor 103 which may be in data communication with an output device 104, a input/output receptacle 106, an input/output slot 108, an evaluating device 110, a vault 112, a camera 114, an input device 116, a networking device 117, a compartment 121 for storing consumer goods 14, and a compartment 123 for storing convenience food products 16.

The kiosk 100 also includes a storage unit 118 and a computer memory 119 in data communication with the processor 103. The storage unit 118 may be, for example, a disk drive that stores programs and data, and the storage unit 118 is illustratively shown storing a program 120 embodying the steps and methods set forth below. It should be understood that the program 120 could be broken into subprograms and stored in storage units of separate computers and that data could be transferred between those storage units using methods known in the art. A dashed outline within the computer memory 119 represents the software program 120 loaded into the computer memory 119 and a dashed line between the storage unit 118 and the computer memory 119 illustrates the transfer of the program 120 between the storage unit 118 and the computer memory 119.

The output device 104 may be an LCD or Plasma type display screen, a printer, or any other appropriate visual and/or audible output device, whether currently available or later invented. It may be desirable for the input device 116 to be placed close to the output device 104, and the input device 116 may include various keys 116A to help in the navigation of various options 140 (discussed below). It will be understood that the shape and placement of the input device 116 and the keys 116A in FIG. 2 are exemplary only, and that the input device 116 may be placed further away from the output 104, or may include different types of keys 116A (e.g., keys displaying letters of the alphabet and numerals). In addition, the input device 116 in different embodiments may include switches, knobs, biometric sensors, and any other appropriate input devices (e.g., iris or voice recognition sensors, fingerprint scanners, et cetera) whether currently available or later invented. If the output device 104 is capable of allowing a customer to scroll through and navigate the various options 140 (e.g., touch screen capability), the output device 104 and the input device 116 may be a single device. Nevertheless, embodiments having an output device 104 with such capability and also a separate input device 116 are also contemplated.

The input/output receptacle 106 may be covered with a cover 106C to which a handle 106H is secured, and a customer may move the cover 106C (e.g., downwardly) by using the handle 106H to gain access to the receptacle 106. The receptacle 106 may alternatively be a drawer, which can be pulled out by the handle 106H. Regardless of its specific construction, the receptacle 106 may be configured to receive and/or dispense valuable items 18 such as precious or semi-precious stones and metals in various forms. The receptacle 106 may also be configured to dispense consumer goods 14 and convenience food products 16. Those skilled in the art will appreciate that the input/output receptacle 106 may be a single receptacle, as previously described, or may instead include multiple receptacles.

The input/output slot 108 may be configured to input and output cash, cards (e.g., gift cards, debit cards, credit cards, etc.), and/or promotional materials such as coupons and vouchers. The input/output slot 108 may be a single slot, or may instead include multiple transfer devices.

The evaluating device 110 is configured to evaluate the contents and price of the valuable item 18. The item 18 may, for example, be placed in the receptacle 106 by a customer, or may have been stored in the vault 112 after being placed in the receptacle 106 by a prior customer (or an owner or authorized attendant of the kiosk 100, et cetera). The evaluating device 110 may include a scale 131, and may employ various methods to determine the contents and price of an item 18, such as methods based on frequency testing, electrical conductivity, thermal conductivity, et cetera.

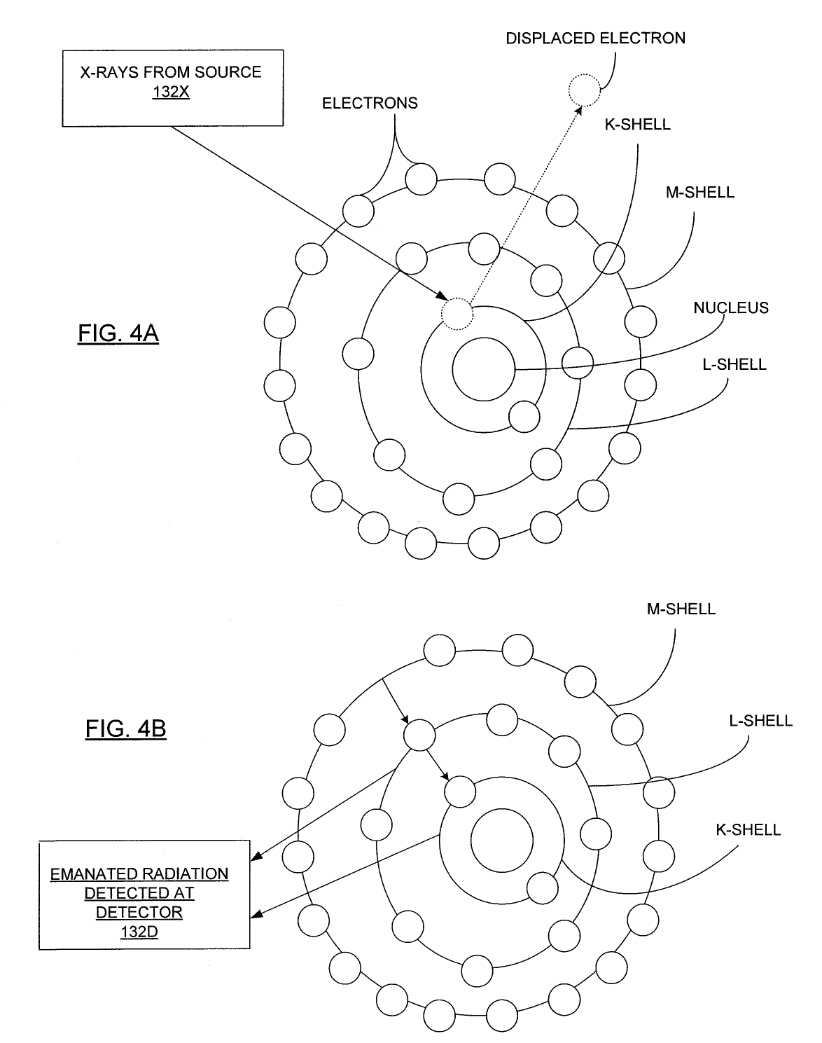

For instance, the evaluating device 110 may include an XRF (x-ray fluorescence) tester 132 which utilizes XRF to determine the types and quantity of metals present in an item 18. More particularly, the XRF tester 132 includes a source 132X, which can generate high energy, short wavelength protons (e.g., x-rays), and the item 18 is struck with these x-rays from the source 132X. The workings of the XRF-tester are explained here with reference to FIGS. 4A-4B.

The item 18, much like other matter, is composed of atoms, which, at their center, have a nucleus (see FIG. 4A). Rotating around the nucleus, in orbits, are negatively charged particles, i.e., electrons. These electrons rotate in different orbits (or shells) around the nucleus, and an electron in one shell has a different energy than an electron in another shell. For example, electrons in the K-shell, which shell is closest to the nucleus, have the lowest energy, whereas electrons in the M-shell, which is further away from the nucleus, have higher energy. Similarly, electrons in the L-shell, which lies between the K-shell and the M-shell, have greater energy than the electrons in the K shell, but less energy than the electrons in the M-shell.

When the item 18 is exposed to radiation emanated by the source 132X, an electron in a low energy shell (e.g., the K-shell) is displaced; thereafter, an electron in a higher energy orbit (e.g., the L-shell) rushes to take its place in the low energy shell. Similarly, the electron in the comparatively higher energy orbit (e.g., the M-shell) rushes to take the place of the electron that has rushed to take the place of the electron originally displaced by the radiation. As there is less energy required to maintain the lower energy orbits, when an electron from a higher energy orbit, e.g., the M-shell, moves and takes the place of an electron in the L-shell, excess energy (i.e., L x-ray) is emitted. Similarly, when the electron in the L-shell takes the place of the electron in the K-shell, excess energy (i.e., K x-ray) is emitted, and so on. These x-rays (e.g., K, L, M, N x-rays) are unique to each metal, akin to a fingerprint, and can then be analyzed by a detector 132D, which compares these x-rays to the known values of various metals. The evaluating device 110 can thus determine the exact composition of the various metals in the item 18 with precision. For example, by using the scale 131 and the XRF tester 132, the evaluating device 110 may find that the item 18 contains one ounce (28.34 grams) of gold, and ten grams of silver.

The evaluating device 110 may then employ a different method to determine whether the item 18 also includes a precious stone. For example, the evaluating device 110 may employ an infrared reflectance meter, a refractometer, a diamond fluorescence machine, a spectroscope, or a combination of these and other known techniques along with the scale 131 to determine the contents, weight, and type of any precious or semi-precious stones that are included in the item 18. For illustrative purposes, consider that after analyzing the item 18, the evaluating device 110 gleans that in addition to the ounce of gold and ten grams of silver, the item 18 includes a diamond that weighs 1 carat (0.2 grams).

The next step entails pricing the item 18. The processor 103, via known communication methods, can access a network 105 (e.g., the Internet). Specifically, the processor 103 accesses one or more websites 105W, which may be dedicated solely to the kiosks 100, using the networking device 117. In some embodiments, the website 105W is password protected and the content on the website 105W is encrypted to prevent unauthorized access; in other embodiments, the website 105W may be a publicly-available site that is not dedicated to the kiosks 100. The website 105W may include the price of each precious or semi-precious gemstone and metal, and may be updated regularly (e.g., daily) by authorized persons to reflect the current rates. The website 105W may also keep track of the area at which a particular kiosk 100 is located, as the price of gemstones and metals often varies with location.

So, for example, the processor 103 of a particular kiosk 100 may determine via the website 105W that the current rate of a diamond in the locality of the kiosk 100 is $1,000 per carat, the current rate of gold is $1,500 per ounce, and that the current rate of silver is 10 cents per gram. The processor 103 may then calculate (using the composition determined by the evaluating device 110) that the item 18 is worth about $2,501, and after deducting certain processing fees, may display the worth of the item 18 on the output device 104.

In some embodiments, the determined worth may be confirmed by using the camera 114; specifically, the camera 114, which may be a digital video (or still) camera, may make an image 136 of the item 18 and securely transmit the image 136 over the web 105. The image 136 may then be viewed by a jeweler or other person via the website 105W or some other website. The jeweler may then confirm that the readings taken by the evaluating device 110 are (or appear to be) correct, and may also modify the worth of the item 18. For example, the jeweler may lower the calculated worth of the item 18 upon finding that the diamond associated with the item 18 has inclusions which were not accounted for, or that the diamond is colored or has some other defect. Or, the jeweler may increase the calculated worth of the item 18 upon finding, for example, that the item 18 is associated with a particular brand.

If such remote valuation methods are employed, a customer may be able to communicate with the jeweler about the specifics of the item 18 by using the input device 116, output device 104, and camera 114; for example, the camera 114 may take a video 136 of the customer and cause it to be transmitted, whereby the video 136 may be viewed, generally simultaneously, by the jeweler. Or, the kiosk 100 may allow two-way video communication between the customer and the jeweler by displaying the jeweler on the output device 104. Or, the customer may instead utilize a telephone number to call the jeweler and discuss any concerns about the calculated worth of the item 18.

After deducting fees (20% for this example, and which may also include a factor of safety to ensure that the item is worth more than the evaluation) from the calculated worth, the offered price (now $2,000.80 in the current example) is displayed on the output device 104, and the customer may choose to sell the item 18. If so, the customer may navigate the input device 116, and the stated amount (again, $2,000.80 in the current example) may be dispensed by the kiosk 100 via the input/output slot 108C.

The item 18 may be stored in the vault 112. The vault 112 may be partitioned into various areas and may be fully encompassed by the casing 102, or may extend into a secure room or other structure through the back or a side of the kiosk 100. The vault 112 may include one or more safety mechanisms to ensure that the vault 112 is accessible only to authorized persons, and may include a hidden GPS device in case anyone attempts to improperly relocate the entire kiosk 100 or the vault 112.

Valuation of the item 18 as discussed above may take some time, and a customer getting an item 18 appraised may wish to utilize this time. Preferably, thus, a customer using the retail location 10 (e.g., kiosk 100) to get his item 18 valuated will also, at the transaction point 20, purchase a convenience food product 16, which the customer may consume while the appraisal is being conducted; or, the customer may instead purchase a consumer good 14 such as a magazine which the customer can browse through while waiting for the valuation to complete. In this manner, the retailing system provides a convenient and efficient manner in which to provide a valuable service to a customer without delaying or interrupting his schedule.

The consumer goods 14 may be stored inside the kiosk 100 within a compartment 121, and the convenience food products 16 may be stored within a compartment 123 (see FIG. 3). A heating or cooling element may be associated with the compartment 123 for storing and/or dispensing the convenience food products 16 at a desirable temperature. A person skilled in the art will understand that the compartments 121 and 123 for storing consumer goods 14 and convenience food products 16 respectively may be single compartments, or may comprise a plurality of compartments.

The outer casing 102 of the kiosk 100 may be such that a customer is able to view the contents of one or both compartments 121, 123 directly, or the contents of the compartments 121, 123 may be displayed on the output device 104 by the processor 103. The customer may be allowed to select a consumer good 14 and/or convenience food product 16 via the input device 116, and the consumer good 14 or convenience food product 16 may be dispensed for the customer by the kiosk 100 through the input/output receptacle 106. Where some or all of the convenience food products 16 are not conducive to being dispensed via the input/output receptacle 106 (for e.g., coffee), the kiosk 100 may include a separate dispensing unit to dispense such food products 16. It is also possible for the consumer goods 14 or food products 16 to be stored at a remote location (e.g., at a store or restaurant that is within a half hour drive from the retail location 10), and for them to be delivered to the retail location 10 after the customer has made his selection via the input device 116.

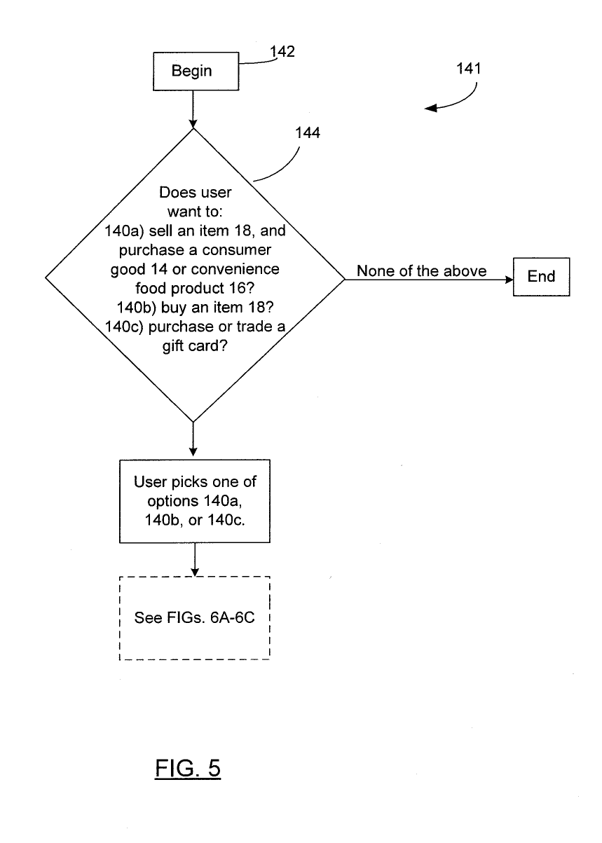

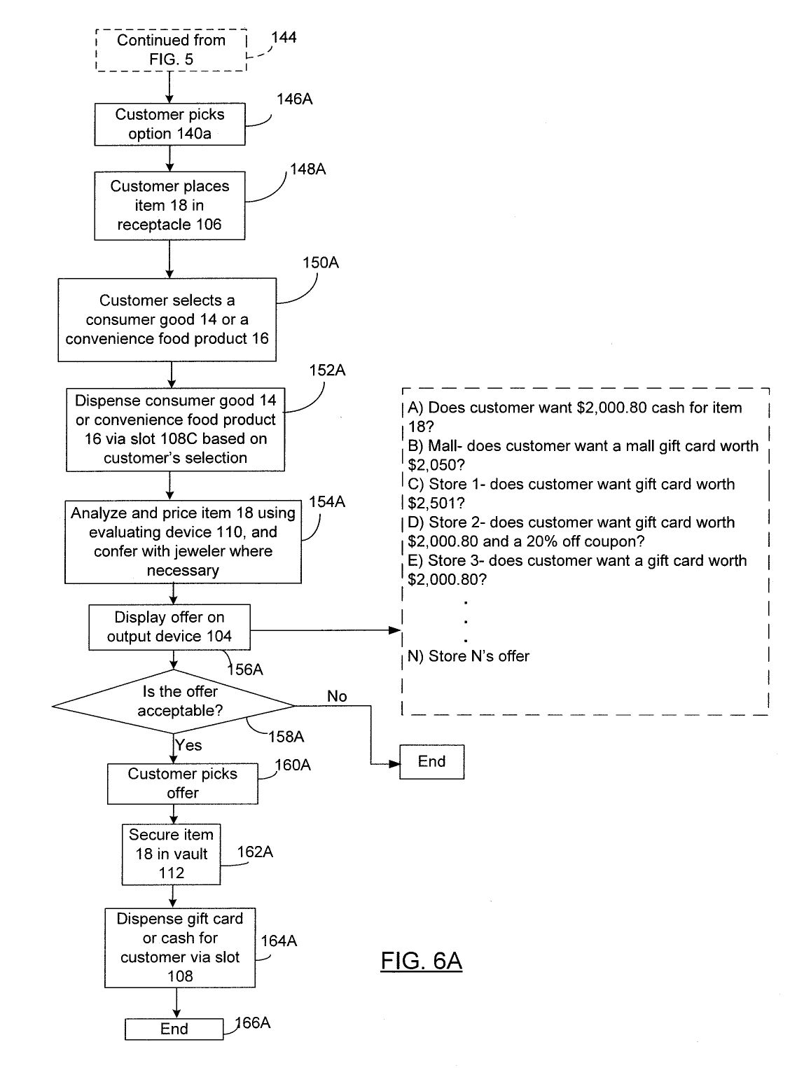

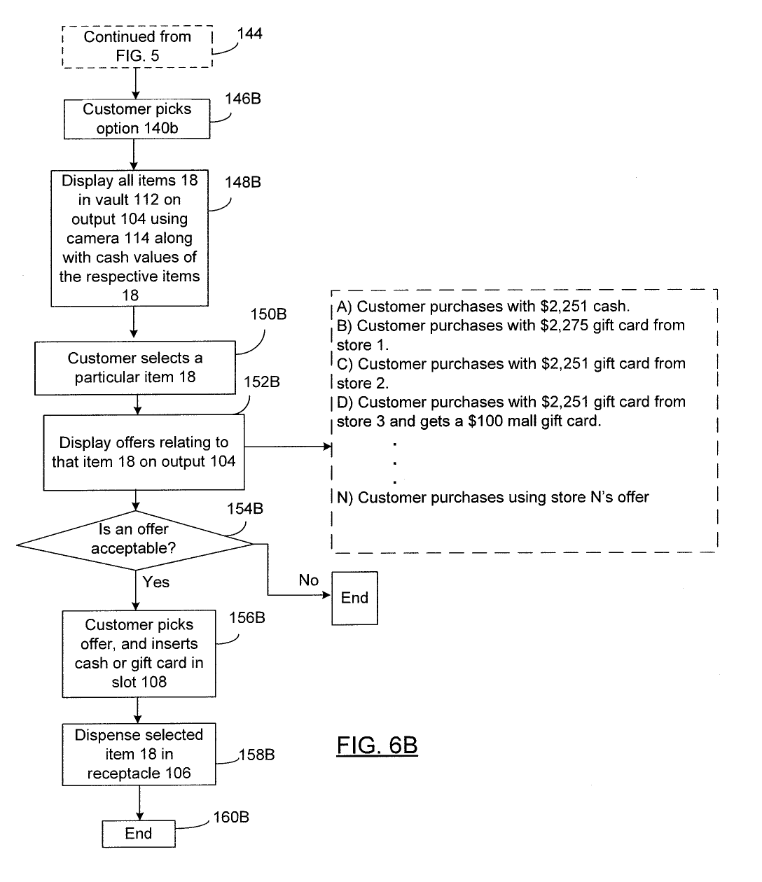

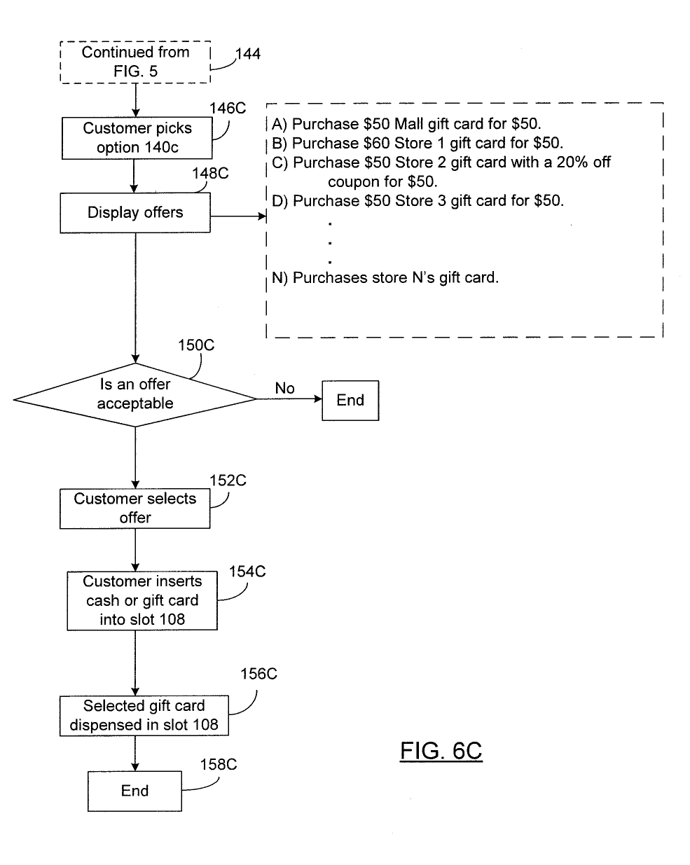

Attention is now directed to FIGS. 5 and 6A-6C, which illustrate programming in the kiosk 100 and a method 141 of using the kiosk 100. In these illustrations, the kiosk 100 is placed, preferably conspicuously, in a mall or shopping area that has at least three stores, i.e., store 1, store 2, and store 3.

As shown in FIG. 5, at step 142, a customer enters the shopping area and approaches the retail location 10 (i.e., kiosk 100 in this example). At step 144, the kiosk 100, via its output device 104, inquires whether the customer is interested in selling an item 18 and purchasing a consumer good 14 or convenience food product 16 (option 140a), buying an item 18 (option 140b), or purchasing or trading a gift card (option 140c). FIG. 6A shows selection of option 140a, FIG. 6B shows selection of option 140b, and FIG. 6C shows selection of option 140c.

By selecting option 140a at step 146A (FIG. 6A), the customer signifies that he intends to sell an item 18, and wants to purchase a consumer good 14 or convenience food product 16. The item 18 may be any item that includes a precious or semi-precious stone or metal, or any item 18 that the customer thinks may include a precious or semi-precious stone or metal. At step 148A, the customer places his item 18 in the receptacle 106. Then, at step 150A, the customer is asked, via the output device 104, whether he wants to purchase a consumer good 14 or a convenience food product 16. At step 152A, the kiosk 100 dispenses the consumer good 14 or convenience food product 16 in line with customer's entry, which the customer may make using the input device 116. The customer may also choose to purchase both a consumer good 14 and a convenience food product 16, or a plurality of either.

At step 154A, the item 18 is evaluated by the evaluating device 110 to determine the contents of the item 18. Specifically, the evaluating device 110 may run one or more tests to determine the composition of the item 18, such as an X-ray fluorescence test by using its XFR tester 132 to determine the presence and composition of any precious or semi-precious metals, and/or tests for precious or semi-precious stones by using the spectroscope. The processor 103 may also ask the customer to input (via input 116) which metals and/or stones the customer want the item 18 to be tested for, and the evaluating device 110 may conduct only the tests pertaining to those metals and stones.

In some embodiments, the processor 103 (and software program 120) may cause the camera 114 to take video 136 (or snapshot) of the item 18 and stream the video 136 (or send the snapshot) over the internet 105, such that the video 136 (or snapshot) can be viewed by a jeweler or other qualified person. This may especially be useful where the tests conducted by the kiosk 100 provide inconsistent results or where the evaluating device 110 indicates that the item 18 is worth more than a predetermined amount, so that the jeweler can verify the worth of the item 18. It is also possible to instead have an attendant on hand that can verify the price of each item 18 and address any concerns of the customer, or for the kiosk 100 to simply refuse any transactions over a predetermined amount. Or, a phone number may be listed on the casing 102 of the kiosk 100 or displayed on the output device 104, allowing a customer to call that number and discuss any general or specific concerns.

Once the evaluating device 110 determines the specific composition of the item 18, the processor 103 may then communicate with the website 105W to determine the current unit price of each constituent metal or stone present in the item 18 in the locality of the kiosk 100. As with the example above, it may be determined that the item 18 has a one carat diamond, an ounce of gold, and 10 grams of silver, and as such, the processor 103 may calculate the item 18 to be worth about $2,501. The processor 103 may then deduct a standard amount or percentage and display on the output 104 the cash amount (e.g., $2,000.80) that the kiosk 100 is willing to pay for the item 18.

As the kiosk 100 additionally has the capability to dispense gift cards, the mall and the stores therein may compete with each other to entice the customer to, instead of cash, accept a gift card from the mall or a store. For example, the mall may offer the customer a gift card for $2,050-$49 more than what the kiosk 100 offers the customer in cash. The customer may consider the additional $49 to be worthwhile, especially because the mall gift card may be utilized at any store in the mall; for instance, the customer may rationalize that since the mall gift card has no imminent expiration date, and that the customer will have to spend cash anyway to purchase items of use (such as clothing, food, gifts, et cetera), that it is a better deal to take the higher value gift card than the cash. If the customer accepts the mall gift card, it would increase the likelihood that the customer would come to the mall again to shop, something which the customer may not have done otherwise. Thus, the presence of the kiosk 100 may entice a customer to come to the shopping area to conveniently sell an item 18, whether for cash or a gift card. And once a customer is at the shopping area to utilize the kiosk 100, the customer may shop at the shopping area after (or before) using the kiosk 100, even if he did not originally intend to do so.

There is no requirement that the mall gift card be priced higher than the cash value of the item 18, and if it is not, the customer may purchase the mall gift card nevertheless, perhaps as a gift, or because it is safer to carry the mall gift card than cash. The mall gift card may also extend to other malls or stores; this may especially be helpful when the kiosk 100 is placed in a store that has a chain of stores. For example, where the kiosk 100 is placed in a Walmart® store, a Bass Pro Shops® store, a Cabela's® store, or a gas station chain, the gift card may extend to all of these respective stores nationwide, or even internationally. Or, certain gift cards may extend to a particular grouping of stores, and also to restaurants, dry cleaning services, bars, salons, et cetera, allowing for a safe and convenient alternative to cash at many of the places that the customer frequents.

The stores within the mall may also (but do not have to) compete with each other to entice the customer to accept their gift card in return for the item 18, and may provide varying incentives to the customer. For example, store 1 may provide a gift card that is worth $2,501, i.e., the actual worth of the item 18 before the processing fee was subtracted, and thereby, agree to absorb the processing fee of the kiosk 100 on behalf of the customer, in return for the opportunity to have the customer shop at store 1. Store 2 may, for example, offer a store 2 gift card for $2,000.80 but add a 20% off coupon as an incentive. These offers will generally be determined in advance, may be changed from time to time, and may vary from kiosk 100 to kiosk 100. Again, however, there is no requirement that a store provide any additional incentives, and as such, store 3 may offer a gift card for $2,000.80, i.e., for the same amount that the kiosk 100 would dispense in cash.

At step 156A, all these offers may be displayed on the output device 104, and at step 158a, the kiosk 100 may inquire as to which offer the customer wants to take advantage of. If the customer picks an offer at step 160A, the kiosk 100 (and more specifically the processor 103 along with program 120) may first cause the item 18 to be secured in the vault 112 at step 162A. This ensures that the customer is unable to retrieve the item 18 after he has made the decision to accept an offer. The kiosk 100 may then, at step 164A, dispense the cash or gift card as selected by the customer in the slot 108, where it can be picked up by the customer. The kiosk 100 may also have the capability to dispense, instead of a gift card that is associated with a particular mall or chain, a debit card that can be used by the customer at any location that accepts debit cards. Or, if the customer desires, the kiosk 100 may transfer the funds electronically to the customer's bank account, or on the customer's behalf, to an internet retailer such as Amazon.com®. Similarly, the kiosk 100 may have the capability to transfer the funds to eBay® (e.g., via the customer's account at PayPal®); or to any other web based account where the funds can subsequently be accessed by the customer or a third party.

Returning now to step 144, if instead of attempting to sell an item 18, the customer wants to purchase an item 18, which item 18 may have been left in the kiosk 100 (i.e., the vault 112) by a prior customer, or an owner of the kiosk 100 or other authorized person, the customer selects option 140b at step 146B (FIG. 6B). The customer may for example be enticed to come to the kiosk 100 to purchase the item 18, instead of going to a jewelry or other store, because the item 18 may be offered at a lower price than it is elsewhere, as the cost of overhead of the kiosk 100 may be lower than that of stores; or, the customer may want to purchase an item 18 immediately (for e.g., as a gift for a party that night), and come to the kiosk 100 because the jewelry stores in the area have closed for the day. Or, for example, the customer may come to the kiosk 100 because the kiosk 100 may allow the customer to pay for an item 18 via a gift card, or because of the location of the kiosk 100.

After the customer selects option 140b at step 146B (FIG. 6B), the processor 103 at step 148B, by using the camera 114, may cause all the items 18 in the vault 112 to be displayed on the output 104 along with their prices in cash, which may have been pre-determined by the evaluating device 110, or may have been set in advance by an owner or authorized user of the kiosk 100. Once the customer selects a particular item 18 at step 150B, the kiosk 100 displays on display 104 the various offers relating to that item 18 at step 152B. These offers may include, for example, an offer from store 1 allowing the customer to purchase the item 18, which has a cash value of $2,251, with a gift card from store 1 for $2,275, and the customer, in his desire to utilize the gift card, may agree to this offer. Store 2 may offer that the customer purchase the item 18 with a gift card having the same cash value as the item 18, and store 3 may offer a $100 mall gift card if the customer purchases the item with a store 3 gift card worth $2,251. As discussed with respect to option 140a, there is no requirement that the offers from the stores be different, or even that every or any store in the shopping area participate in making the offers. Indeed, the kiosk 100 may be used inside a single retail store and only provide or accept gift cards from that store (though provided gift cards may be used in subsequent transactions to purchase different gift cards). A person skilled in the art will appreciate that the offers discussed with respect to the options 140, as well as the processing fees discussed herein are only exemplary.

If an offer is acceptable to the customer at step 154B, the customer picks the desired offer at step 156B and inserts into the slot 108 the cash or gift card according to the offer. This cash or gift card may also be secured in the vault 112 or a different secure area. Upon securing the cash or gift card, the kiosk 100 dispenses the desired item 18 into the receptacle at step 158B, thereby completing the transaction at step 160B. It will be appreciated by those skilled in the art that in addition to selling or buying an item 18 under options 140a, 140b respectively, the kiosk 100 may also, after deducting its fees, allow the customer to trade his item 18 for other item(s) 18 of comparable value.

Returning again to step 144, the kiosk 100 may in some embodiments also be used as a hub for buying gift cards relating to at least one store. For example, if the customer picks option 140c at step 146C (FIG. 6C), then at step 148C the kiosk 100 may display any or all offers relating to gift cards for cash. As before, the mall and the stores therein may compete with each other to entice the customer to purchase their gift card, by providing, for example, extra cash value for a gift card, or coupons or other incentives along with the gift card. Once a customer determines that an offer is acceptable at step 150C and selects an offer at step 152C, the customer inserts cash into the slot 108 at step 154C.

The kiosk 100 may also allow the customer to exchange a gift card from one store for a gift card from another store; for example, store 1 (or the mall) may offer to give a customer a gift card from store 1 (worth, e.g., $40) in exchange for a gift card from store 2 (worth, e.g., $50). Store 1 may then sell the gift card from store 2 via the kiosk 100 to another customer, and by virtue of the gift card from store 1, increase the likelihood that the customer will subsequently shop at store 1. The process ends at step 158C after the kiosk 100, at step 156C, dispenses the gift card selected by the customer.

The kiosk 100, thus, may allow a customer to conveniently have an item 18 having a precious or semi-precious metal or stone appraised and sold while providing the customer with avenues to utilize the time spent during the appraisal productively, to buy or trade an item 18, to buy a gift card for cash, or to exchange a gift card.

While the kiosk 100 has been detailed here in FIGS. 5 and 6A through 6C as being within a mall or shopping area, a person skilled in the art will appreciate that the kiosk 100 may be placed at any point-of-purchase, or at any other area that has high traffic or that has potential to attract high traffic. For example, the kiosk 100 may be placed within or outside a gas station, and may be integrated with the payment mechanisms utilized by the gas station. And, to illustrate, a customer having an item 18 for which the kiosk 100 is willing to pay $50 may utilize the kiosk 100 to pay $25 for gas and $5 for a convenience food product 16, and obtain the remaining $20 from the kiosk 100 in the form of a secure debit card that the customer can subsequently use at any location that accepts debit cards. It is also possible to place different types of kiosks 100 in proximity to each other to create an appraisal area 170. For example, a kiosk 100 that evaluates valuable items 18, dispenses consumer goods 14 and/or food products 16, and enables a user to trade his item 18 for another item 18 (or cash or gift cards et cetera) may be placed within one square mile of a kiosk 101 that has the ability to evaluate valuable items 18 and which enables a user to trade his item 18 for something of value, but which does not carry or dispense food products 16 or consumer goods 14.

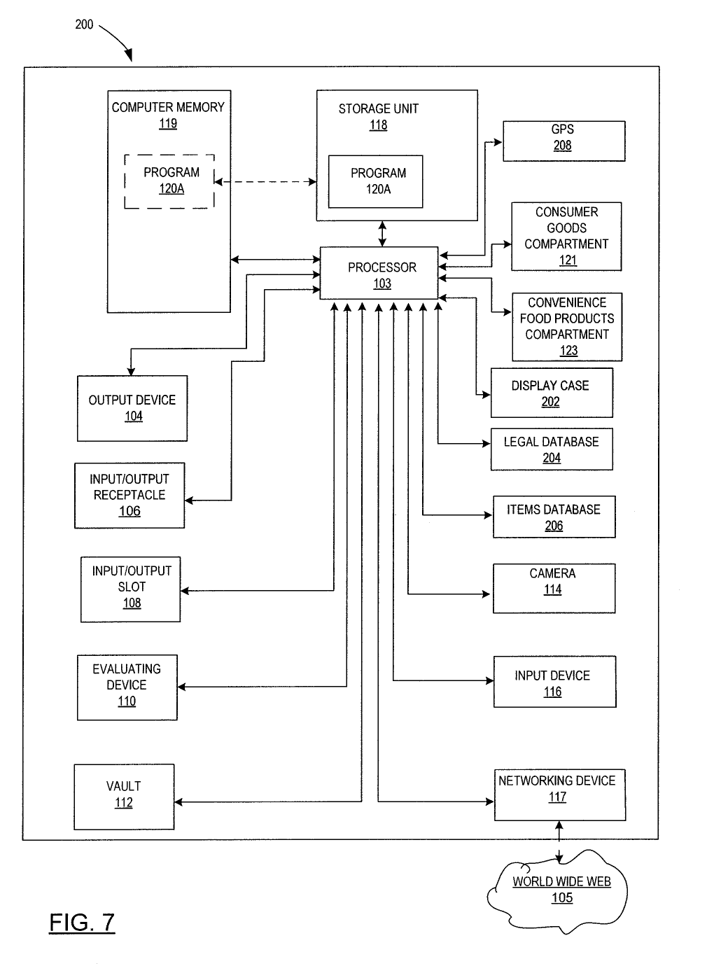

Attention is now directed to FIG. 7, which shows an alternate embodiment 200 of the kiosk that is substantially similar to the embodiment 100, except as specifically noted and/or shown, or as would be inherent. Further, those skilled in the art will appreciate that the embodiment 100 (and thus the embodiment 200) may be modified in various ways, such as through incorporating all or part of the disclosure provided herein. For uniformity and brevity, corresponding reference numbers may be used to indicate corresponding parts, though with any noted deviations.

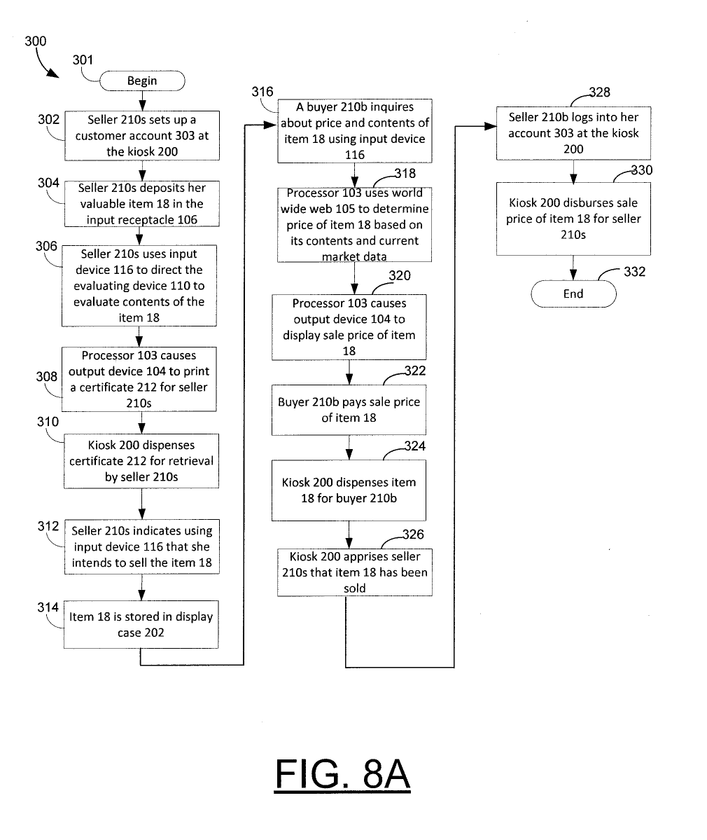

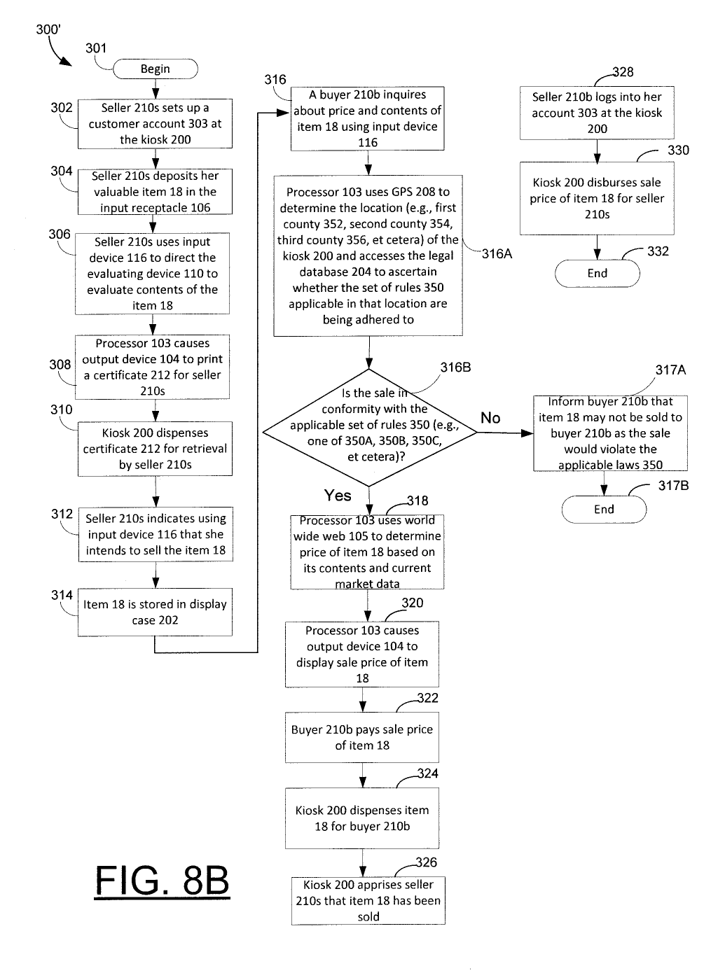

One of the main differences between the kiosk 100 and the kiosk 200 is that the kiosk 200 may further include a display case 202, a legal database 204, an items database 206, and a global positioning system 208. The display case 202 may comprise reinforced glass or other suitable materials, and valuable items 18 deposited in the kiosk 200 by a customer may be displayed in the display case 202 to allow other customers to purchase the same. Attention is directed to FIG. 8A, which illustrates a method 300 for allowing customers to sell one or more of their valuable item(s) 18 via the kiosk 200. People of skill in the art will appreciate that a program 120A stored in the storage unit 118 of the system 200, akin to the program 120 of the system 100, may include programming to allow one or more of the steps outlined below to be effectuated.

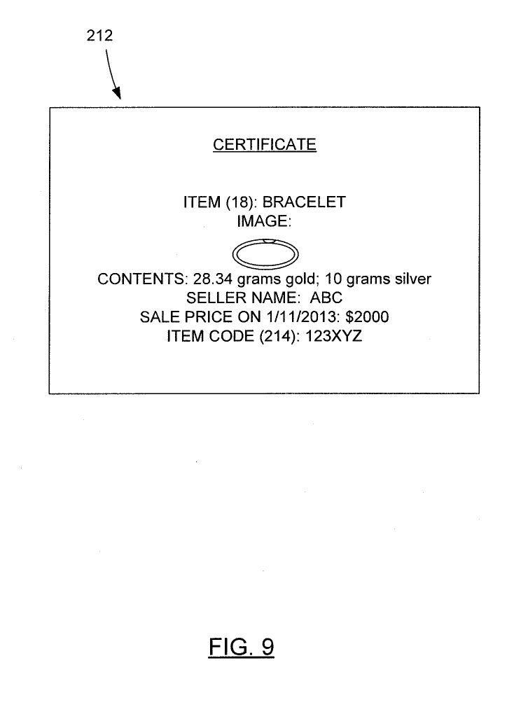

The method 300 may begin at step 301, and at step 302, a customer (or seller) 210s may set up a customer account 303 at the kiosk 200 using the input device 116 and the output device 104. The customer account 303 may include the name and contact information of the seller 210s (e.g., e-mail address, home address, telephone number, et cetera), and may be protected by the seller 210s via a password. At step 304, the seller 210s may deposit his or her valuable item 18 in the input receptacle 106. At step 306, the seller 210s may use the input device 116 to direct the evaluating device 110 to evaluate the contents of the valuable item 18. At step 308, the evaluating device 110 may evaluate the item 18, using for example, one or more of the evaluating techniques outlined above. Assume that the evaluating device 110 determines that the item 18 contains one ounce (28.34 grams) of gold, and ten grams of silver. At step 308, the processor 103 may cause the output device 104 to print out a certificate 212 (see FIG. 9) for the seller 210s. The certificate 212 may include the contents of the item 18, a current sale price of the item 18 (which as discussed above may be determined using current market data), an image of the item 18 (taken, for example, by the camera 114), the name and contact information of the seller 210s, and may further include a unique code 214 tied to that specific item 18. The code 214 may be numeric or alpha-numeric, and the code 214 may be stored in the items database 206 (and/or the storage unit 118) along with the contents of and other information about the item 18. At step 310, the certificate 312 may be dispensed by the kiosk 200 and retrieved by the seller 210s. At step 312, the seller 210s may use the input device 116 to indicate to the kiosk 200 that she intends to sell the item 18, and at step 314, the kiosk 200 may store the item 18 in the display case 202 where it can be viewed by potential customers. The seller 210s may also decide to not sell her item 18, in which case the item 18 may be returned to the seller 210s via the output receptacle 106 (upon payment of a fee, for example).

At step 316, a customer (or buyer) 210b may use the input device 116 to inquire about the price and contents of the valuable item 18 deposited by the seller 210s. At step 318, the processor 103 may use the world wide web 105 (e.g., the website 105w) to determine the price of the item 18 based on the current market value of its contents (gold and silver in this example). At step 320, the processor 103 may cause the output device 104 to display the contents and the sale price of the item 18, which may include, for example, a storage and/or processing fee. At step 322, the buyer 210b may pay the sale price (e.g., deposit cash, a certified check, money order, et cetera, in the input slot 108), and at step 324, the kiosk 200 may dispense the item 18 for the buyer 210b.

At step 326, the processor 103 may apprise the seller 210s that her valuable item 18 has been sold. For example, the processor 103 may use the networking device 117 to contact the seller 210s through e-mail or an automated telephone message (e.g., via voice over internet protocol). At step 328, the seller 210s may log into her account 303 at the kiosk 200. At step 330, the kiosk 200 may disburse the sale price (e.g., dispense as cash, check, kiosk credit, gift card, et cetera) of the item 18 to the seller 210s after subtracting a processing fee. The method 300 may end at step 332. While the method 300 has been illustrated herein with respect to a single item 18, people of skill in the art will appreciate that a seller 210s may track and sell multiple items 18 using the kiosk 200.

The kiosk 200 (via the processor 103 and the program 120A) may afford the seller 210s with much flexibility during the selling process. For example, the seller 210s may be able to track the sale price of her valuable item 18 on a day to day basis by using the item code 214 on the certificate 212. Specifically, the seller 210s may log in to the account 303 over a network at home or another location (e.g., using the website 105W or another website), and by entering the item code 214, may glean the current sale price of her item 18 based on the up-to-date price of its constituents. The seller 210s may also be allowed in some embodiments to take the item 18 off the market (e.g., if the price of the item 18 fluctuates below a desirable value), either remotely or at the kiosk 200. In this case, the kiosk 200 may automatically shift the item 18 from the display case 202 to the vault 112, and allow the seller 210s to retrieve the same upon payment of a fee.

Further, in some embodiments, the seller 210s may be allowed to set a minimum sale price for the item 18. The minimum sale price may be set by the seller 210s at the time she deposits her item 18 in the kiosk 200 for sale, or at a later time (e.g., remotely via the account 303). The kiosk 200 may regularly evaluate the sale price of the item 18 based on the current price of its constituents, and take the item 18 off the market (e.g., move it from the display case 202 to the vault 112) if the current sale price of the item 18 falls below the minimum sale price.

In some embodiments, the kiosk 200 may allow potential buyers 210b to place bids for the valuable item 18. Specifically, each potential buyer 210b may be directed to create an account 303 and place a bid for the item 18, and the seller 210s may be allowed to remotely accept or decline the bids. This functionality may provide the seller 210s with a convenient way to ascertain the actual market value and demand for her item 18. The seller 210s, in some embodiments, may also be allowed to view (e.g., remotely by signing into the account 303 or at the kiosk 200) the contents of the items database 206, and to trade her item 18 with an item 18 deposited in the kiosk 200 by another seller.

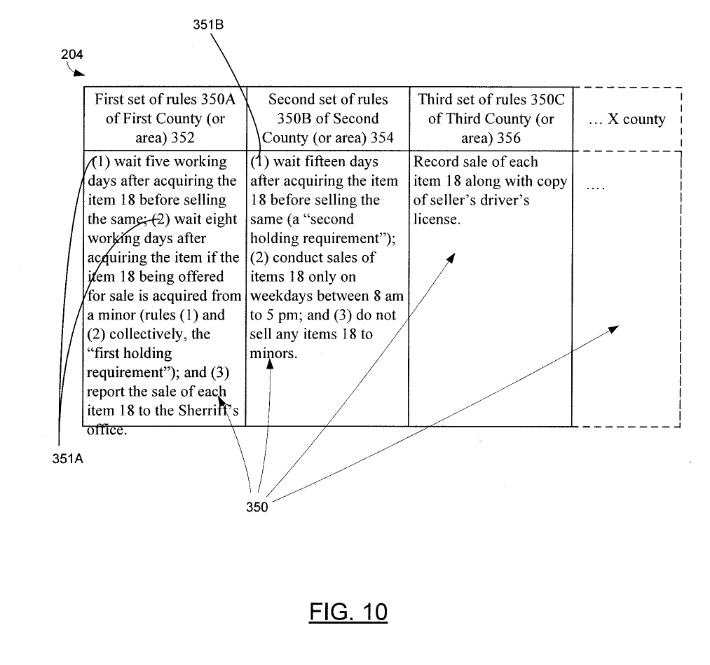

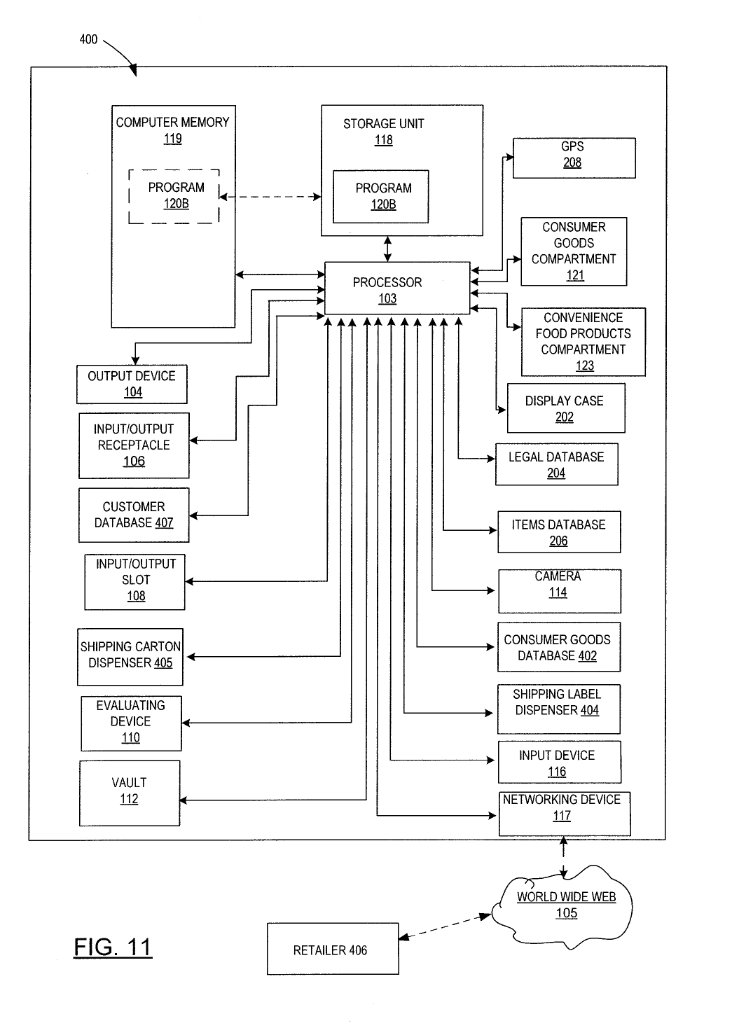

People of skill in the art appreciate that various states, counties, municipalities, jurisdictions, areas, etc., may have differing laws (or sets of rules) 350 governing the sale of valuable items 18, and that these rules 350 may include varying holding requirements 351. For example, a first set of rules (or laws) 350A of a first county (or area) 352 (FIG. 10) may require that a seller of valuable items 18 comprising precious metals: (1) wait five working (or any other fixed number of) days after acquiring the item 18 before selling the same; (2) wait eight working days after acquiring the item 18 if the item 18 being offered for sale is acquired from a minor (rules (1) and (2) collectively referred to herein as a “first holding requirement” 351A); and (3) report the sale of each item 18 to the Sheriff's office. A second set of laws (or rules) 350B of a second county (or area) 354 may require that the seller: (1) wait fifteen days after acquiring the item 18 before selling the same (i.e., a “second holding requirement” 351B); (2) conduct sales of items 18 only on weekdays between 8 am to 5 pm; and (3) not sell any items 18 acquired from minors. A third set of laws 350 of a third county (or area) 356 may require that the sale of each valuable item 18 be recorded along with a copy of the driver's license of the seller. These various laws 350 may be stored in the legal database 204. The program 120A may include programming to allow the kiosk 200 (and specifically, the processor 103) to determine the current location of the kiosk 200 using the global positioning system 208, and to automatically tailor its sales to adhere to the respective laws 350 of that county (or state, municipality, et cetera). For example, if the kiosk 200 is located in the first county 352, the kiosk 200 may automatically hold the item 18 (e.g., in the vault 112) for five working days (or eight working days if the item 18 is being sold by a minor) before it shifts the item 18 from the vault 112 to the display case 202 and report the sale of each item 18 to the Sheriff's office (using, for example, the output device 104 and the networking device 116). If, on the other hand, the kiosk 200 is located in the second county 354, the kiosk 200 may automatically hold the item 18 for fifteen days before offering it for sale, conduct the sales only during the designated times (i.e., between 8 am and 5 pm in this example), and ensure (e.g., by requiring each seller to submit a valid driver's license or other photo id., and/or by using facial recognition or other imaging software) that minors are not involved in the sales of items 18.

To illustrate, attention is directed now to FIG. 8B which shows a method 300′ that is generally identical to the method 300, except as specifically noted and/or shown, or as would be inherent. Further, those skilled in the art will appreciate that the method 300 (and thus the embodiment 300′) may be modified in various ways, such as through incorporating all or part of the disclosure provided herein. For uniformity and brevity, corresponding reference numbers may be used to indicate corresponding parts, though with any noted deviations. The main difference between the methods 300 and 300′ may be that the method 300′ may further include steps 316A, 316B, 317A, and 317B that were not shown in FIG. 8A with respect to the method 300.

Specifically, after the buyer 210b inquires about the price and contents of the valuable item 18 using the input device 116 at step 316 in the method 300′, at step 316A, the processor 103 may use the GPS 208 to determine the location of the kiosk 200 and access the legal database 204 to ascertain whether the set of rules 350 applicable in that location are being adhered to. For example, if the kiosk 200 is located in the first county 352, the processor 103 may access the legal database 204 to ensure that the sale is in conformity with the first set of rules 350A (including the first holding requirement 351A). If the processor 103 determines at step 316B that the sale is in conformity with the applicable set of rules (or laws) 350, it may proceed to step 318 as discussed above with respect to the method 300. If, on the other hand, the processor determines at step 316B that the sale is not in conformity with the applicable set of rules 350 (e.g., where the sale is in the second county 354 and the buyer 210B happens to be a minor), the processor 103 may at step 317A inform the buyer 210b (using, e.g., the output device 104) that the sale cannot be completed because it would violate the applicable rules 350 and the method may end at step 317B.

The program 120A may allow the legal database 204 to be remotely updated (e.g., via the website 105W or another website) to reflect the current status of the laws of each jurisdiction (e.g., of counties 352, 354, and 356). For example, if the laws 350 of the second county 354 are revised to amend the holding period of items 18 under the second holding requirement 351B from fifteen days to twenty days, the kiosk 200 may automatically implement this change upon the updating of the legal database 204. The kiosk 200, via the global positioning system 208, may also take into account any redistricting that affects the laws 350 governing the sale of precious items 18.

Attention is now directed to FIG. 11, which shows an alternate embodiment 400 of the kiosk that is substantially similar to the embodiment 200, except as specifically noted and/or shown, or as would be inherent. Further, those skilled in the art will appreciate that the embodiment 200 (and thus the embodiment 400) may be modified in various ways, such as through incorporating all or part of the disclosure provided herein. For uniformity and brevity, corresponding reference numbers may be used to indicate corresponding parts, though with any noted deviations.

One of the primary differences between the kiosk 200 and the kiosk 400 is that the kiosk 400 may further include a consumer goods database 402 and a shipping label dispenser 404 for dispensing a fold-under (or other) label 500. The kiosk 400 may optionally also include a shipping carton dispenser 405. The kiosk 400 may be located at a gas station, a pawn shop, a retail store, or any other suitable location, and may be operated by or on behalf of a retailer (or another entity) 406. The retailer 406 may be a brick and mortar retail store (e.g., Macy's, JC Penney, Dillards, et cetera), an online retailer 406 (e.g., Amazon.com, Overstock.com, et cetera), a retailer 406 that sells merchandize both in brick and mortar stores and online (e.g., Macy's), or an online sale/trade facilitator (e.g., eBay.com). As shown in FIG. 11, the retailer 406 may in some embodiments be able to wirelessly communicate with the system 400 (e.g., over the world wide web 105).

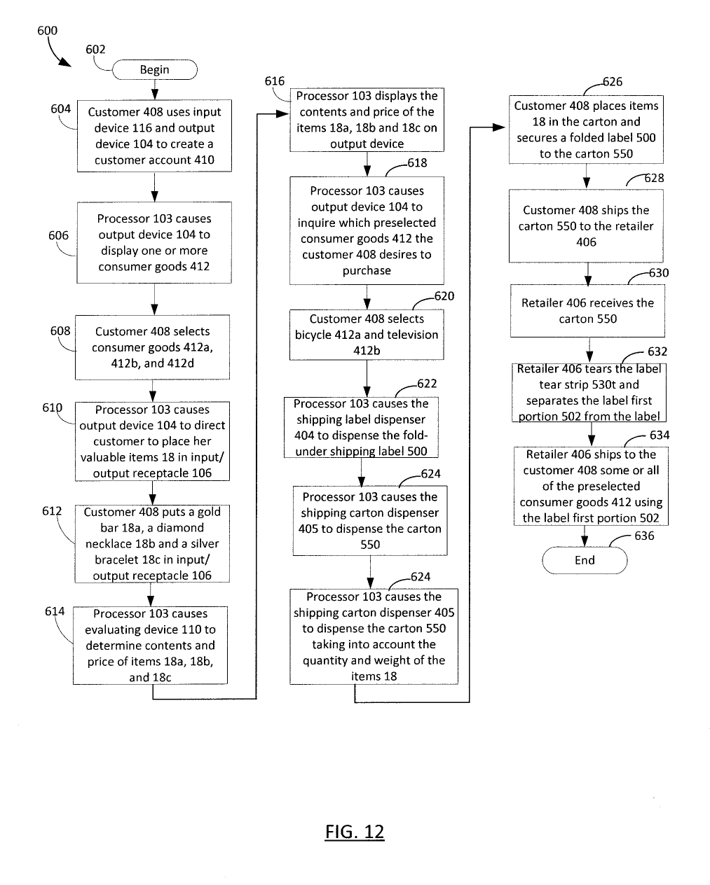

FIG. 12 illustrates a method 600 for allowing a customer 408 to conveniently trade one or more of her valuable items 18 for consumer goods. People of skill in the art will appreciate that a program 120B stored in the storage unit 118 of the system 400, akin to the program 120 of the system 100, may include programming to allow one or more of the steps outlined below to be effectuated. People of skill in the art will further appreciate that one or more elements of the system 400 shown in FIG. 11 (e.g., the legal database 204) may be optional and may not be required during performance of the method 600. Of course, these optional elements may be incorporated in the system 400 where, for example, one system (e.g., the system 400) is intended to encompass the functionality of the other systems (e.g., the system 200) disclosed herein.

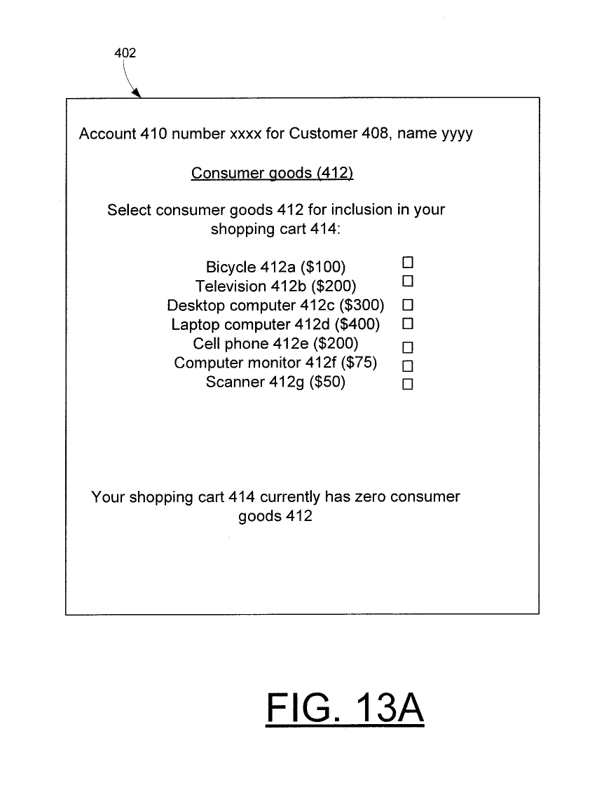

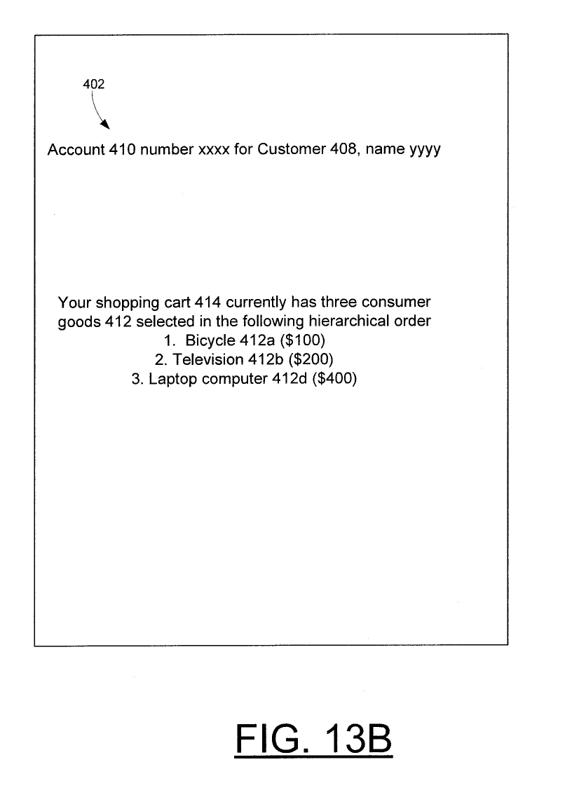

The method 600 may begin at step 602, and at step 604, the customer 408 may use the input device 116 and the output device 104 to create a customer account 410 at the kiosk 400. The customer account 410 may include the name and contact information of the customer 408 (e.g., e-mail address, home address, telephone number, et cetera), and may be protected by the customer 408 via a password. At step 606, the processor 103 may cause the output device 104 to display one or more consumer goods 412 (e.g., consumer goods 412a through 412g, see FIG. 13) in the consumer goods database 402 along with their respective prices (and specifications, model numbers, images, et cetera). The consumer goods 412 may be any goods that are commonly purchased by consumers (e.g., electronics, books, furniture, clothing, et cetera), and the consumer goods database 402 may be remotely updated (e.g., by the retailer 406 via the website 105W or another website) to reflect current buying trends. Further, people of skill in the art will appreciate that the consumer goods 412 displayed at a particular kiosk 400 may depend on the geographical location of that kiosk 400 as determined by the global positioning system 208; for example, the consumer goods 412 displayed at a kiosk 400 located in Colorado may include skiing equipment, whereas the consumer goods 412 displayed by a kiosk 400 located in Arizona may include ATVs (all-terrain vehicles) instead.

At step 608, the customer 408 may select one or more of these consumer goods 412 for inclusion in a shopping cart 414 using the input device 116. Assume for the purposes of this example that the customer 408 selects consumer goods 412a, 412b, and 412d for inclusion in her shopping cart 414 (see FIG. 13B). At step 610, the processor 103 may cause the output device 104 to direct the customer 408 to place one or more of her valuable items 18 in the input receptacle 106. Assume that the customer 408 puts in the receptacle 106 a gold bar 18a, a diamond necklace 18b, and a silver bracelet 18c at step 612. At step 614, the processor 103 may cause the evaluating device 110 to determine the sale price of the items 18a, 18b, and 18c based on the quantity and current price of their respective constituents. At step 616, the processor 103 may display the contents and price of the items 18a, 18b, and 18c on the output device 104. Assume only for the purpose of this example that after the deduction of a processing fee, each of the gold bar 18a, the diamond necklace 18b, and the silver bracelet 18c has a sale price of $100. At step 618, the processor 103 may cause the output device 104 to inquire which of the preselected consumer goods 412 (i.e., bicycle 412a, television 412b, and laptop computer 412d) the customer 408 wishes to purchase. Assume that the customer 408 selects consumer goods 412a and 412b at step 620 using the input device 116. In some embodiments, this step may be omitted and the kiosk 400 may automatically select one or more consumer goods 412 for the customer 408 from her shopping cart 414.

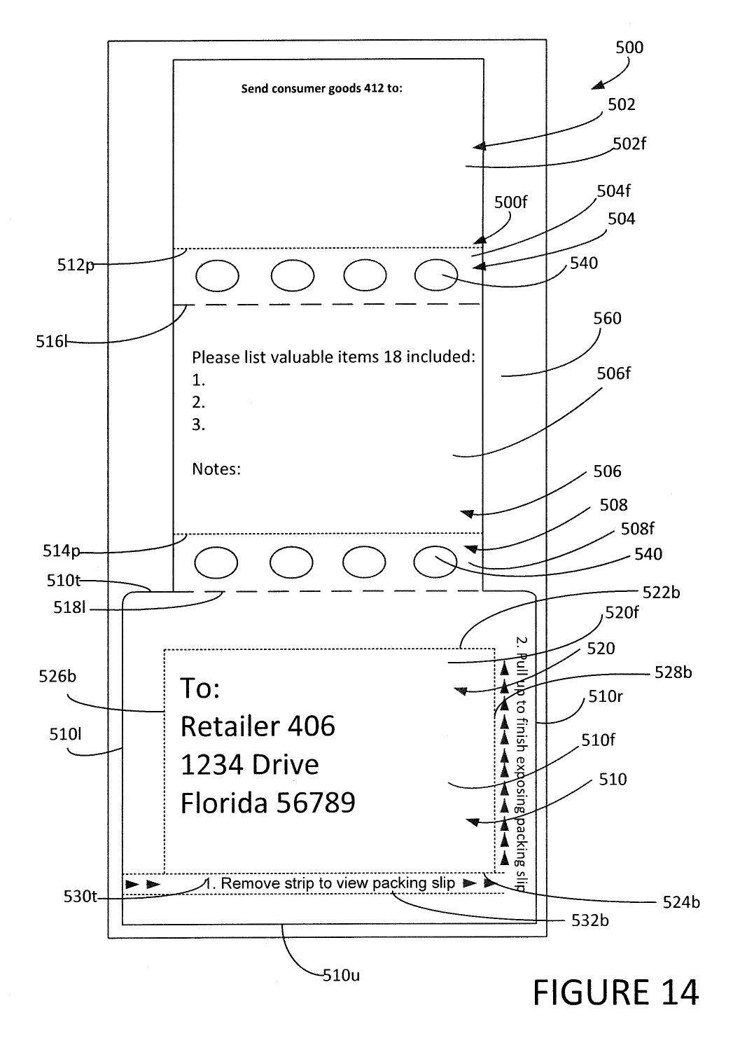

At step 622, the processor 103 may cause the shipping label dispenser 404 to dispense the fold-under shipping label 500. Attention is now directed to FIGS. 14 to 18 that show the fold-under label 500.

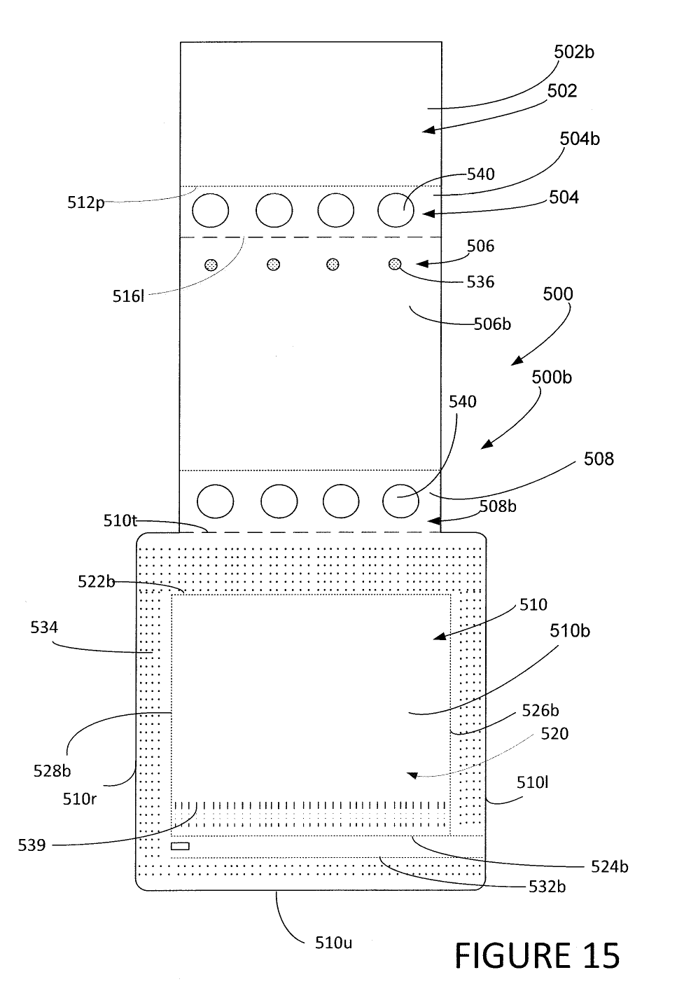

A front side 500f of the fold-under label 500 is shown in FIG. 14, while a back side 500b of the fold-under label 500 is shown in FIG. 15. The fold-under label 500 may include a first portion 502 (or inner label) having a front face 502f and a back face 502b, a second portion 504 having a front face 504f and a back face 504b, a third portion 506 having a front face 506f and a back face 506b, a fourth portion 508 having a front face 508f and a back face 508b, and a fifth portion 510 having a front face 510f and a back face 510b. The front faces 502f, 506f, and 510f of the first, third, and fifth portions, respectively, may all be configured for the printing of indicia. A first perforated border 512p may separate the first portion 502 from the second portion 504, and a second perforated border 514p may separate the third portion 506 from the fourth portion 508. A first line of weakness 5161 may separate the second portion 504 from the third portion 506, and a second line of weakness 5181 may separate the fourth portion 508 from the fifth portion 510.

The fifth portion 510 may include an outer label 520 defined by a first lateral perforated border 522b, a second lateral perforated border 524b, a first vertical perforated border 526b, and a second vertical perforated border 528b. The fifth portion 510 may further include a tear strip 530t defined by the second lateral perforated border 524b and a third lateral perforated border 532b. The first lateral perforated border 522b may be adjacent a top side 510t of the fifth portion 510, the third lateral perforated border 532b may be adjacent a bottom side 510u of the fifth portion 510, the first vertical perforated border 526b may be adjacent a left side 5101 of the fifth portion 510, and the second lateral perforated border 528b may be adjacent a right side 510r of the fifth portion 510.

Adhesive 534 may be provided at the back face 510b of the bottom portion 510 between the top side 510t and the first lateral perforated border 522b, the left side 5101 and the first vertical perforated border 526b, the right side 510r and the second vertical perforated border 528b, and the bottom side 510u and the third lateral perforated border 532b. Additional adhesive 536 may be provided on the back face 506b of the third portion 506 adjacent the first line of weakness 5161. Release material (e.g., silicone) may be provided adjacent the second lateral perforated border 524b in a release area 539.

The second portion 504 and the fourth portion 508 may each have gaps 540 extending therethrough. While the gaps 540 are shown in the figures as being generally circular, people of skill in the art will appreciate that the gaps 540 may be of other regular or irregular shapes (e.g., a triangle, a square, a voided strip, et cetera).

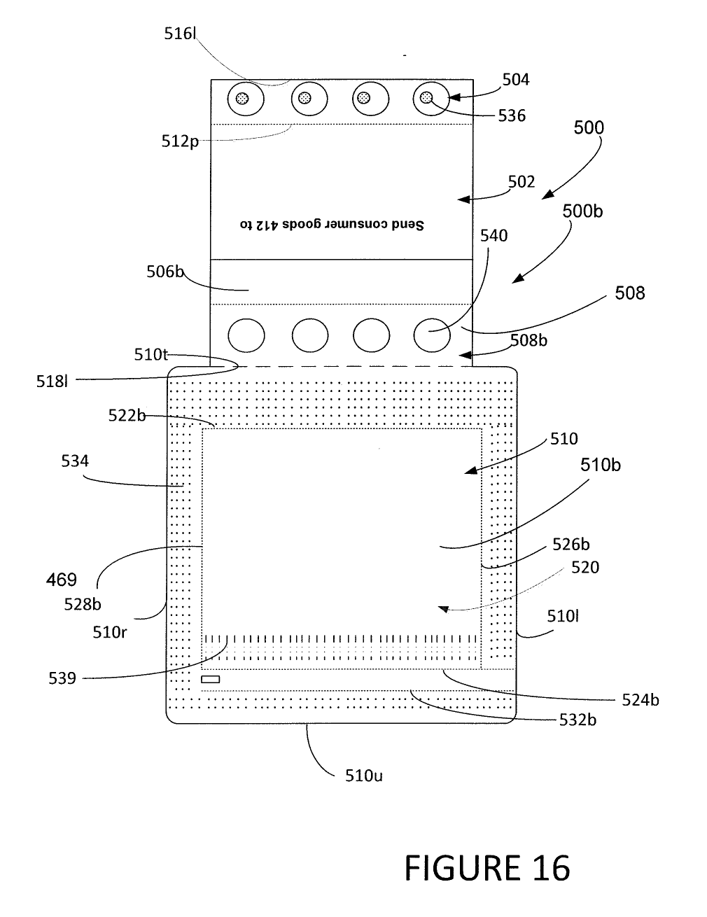

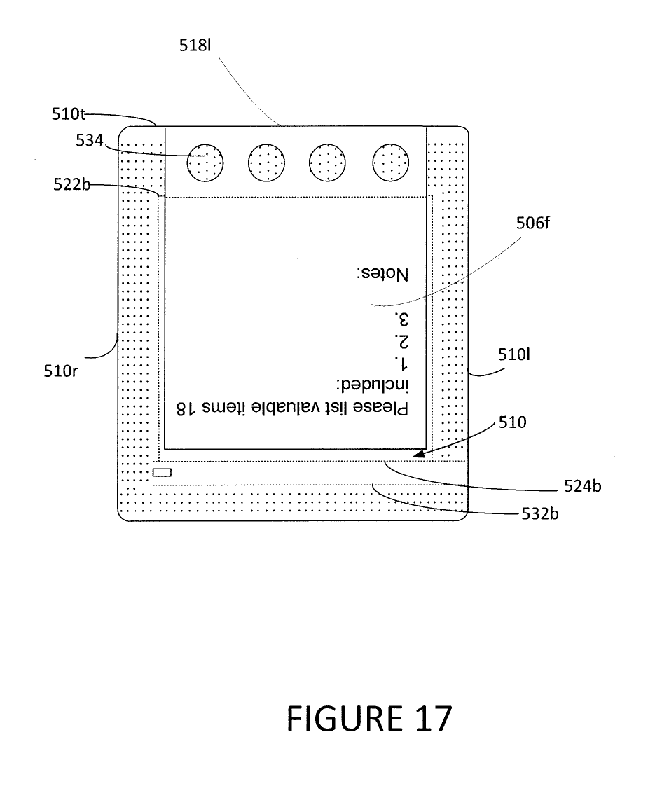

The first portion 502 and the second portion 504 may be configured to be collectively folded along the first line of weakness 5161 behind the third portion 506 such that the back faces 502b, 504b of the first and second portions 502, 504, respectively, are adjacent the back face 506b of the third portion 506. When so folded, the adhesive 536 on the back face 506b of the third portion 506 may extend through the gaps 540 in the second portion 504 (see FIG. 16). The third and fourth portions 506, 508, along with the first and second portions 502, 504 that are folded behind the third portion 506, may thereafter be collectively folded behind the fifth portion 510 along the second line of weakness 5181 (see FIG. 17). When so folded, the adhesive 534 in the fifth portion 510 between the top side 510t of the fifth portion 510 and the first lateral perforated border 522b may extend through the gaps 540 in the fourth portion 508, and the adhesive 536 in the third portion 506 may correspond to the release material in the release area 539. In part because of the gaps 540, the back face 510b of the bottom portion may be secured to all four sides of a shipping carton or other package. A release liner 560 (FIG. 14) may be releasably secured to the back side 500b of the label 500, and may be removed before use.

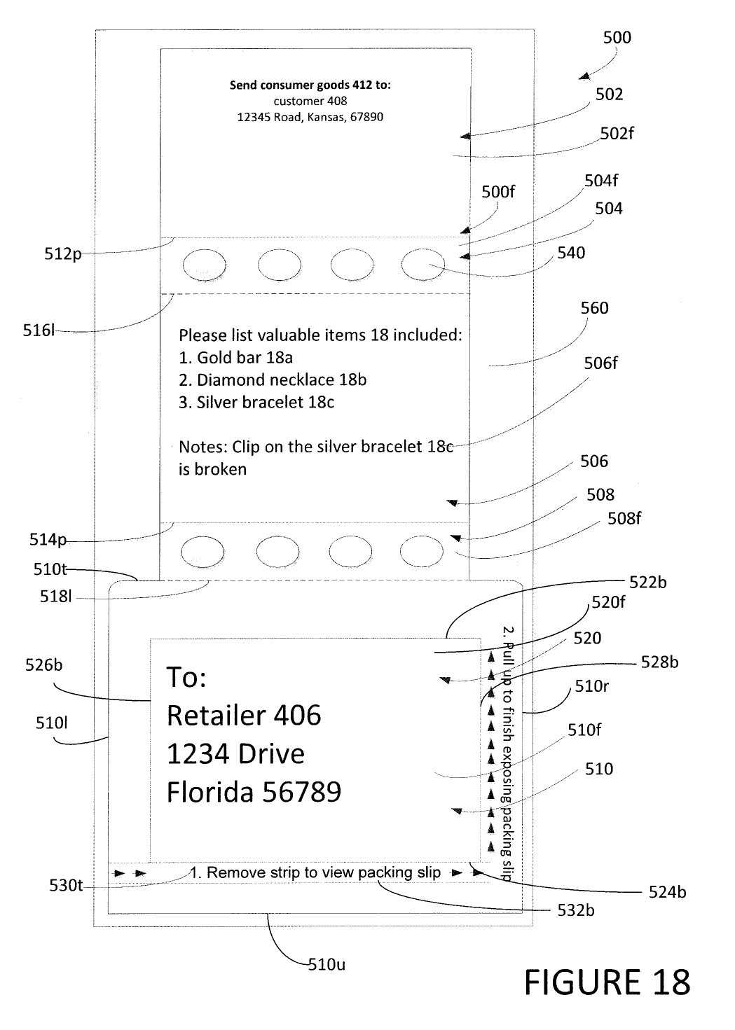

While not required, the processor 103 may also print indicia on the shipping label 500 (e.g., using the output device 104 or another printer) before it is dispensed to the customer 408 at step 622. Specifically, as shown in FIG. 18, the processor 103 may cause the output device 104 to print the name and address of the customer 408 on the front face 502f of the label first portion 502, and to print on the front face 506f of the third portion 506 a listing of the valuable items 18 (i.e., the gold bar 18a, the diamond necklace 18b, and the silver bracelet 18c in this example). This information may be entered by the customer 408 for printing on the label 500 using the input device 116 (e.g., at step 612). The customer 408 may also be allowed to use the input device 116 to add any notes that the customer 408 wishes to be considered by the retailer 406.

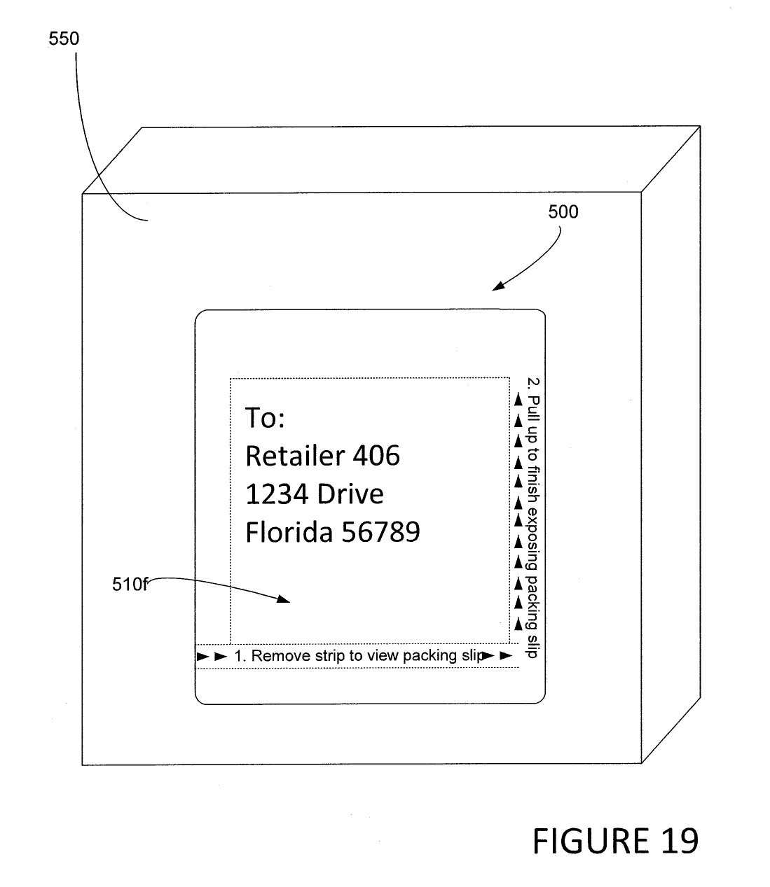

Returning to the method 600 at FIG. 12, at step 624, the processor 103 may cause the shipping carton dispenser 405 to dispense for the customer 408 via the output receptacle 106 a shipping carton 550 (FIG. 19). The shipping carton 550 may be dispensed by the kiosk 600 in folded form, and may be configured for use (as in FIG. 19) by the customer 408. In dispensing the carton 550, the kiosk 400 may take into account the weight and number contents of the valuable items 18 being shipped by the customer 408. For example, the kiosk 400 may dispense a larger and/or sturdier carton 550 to a customer 408 who is shipping multiple or heavy items 18.

At step 626, the customer 408 may place her valuable items 18 within the shipping carton 550, fold the fold-under label 500 as discussed above, and secure the label 500 to the carton 550 (see FIG. 19). At step 628, the customer 408 may ship the carton 550 to the retailer 406 using for example the United States Postal Service or another postal service.

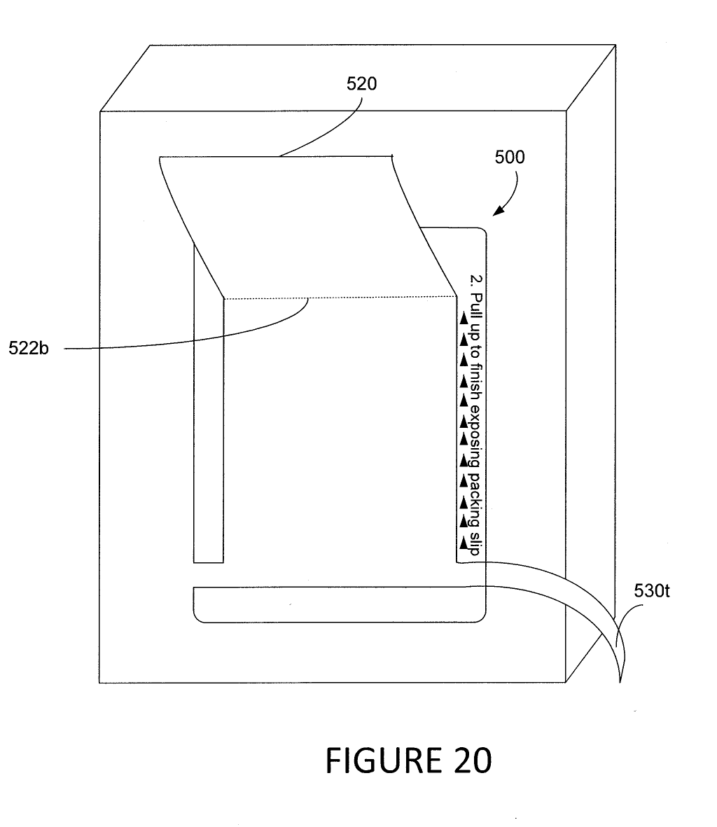

At step 630, the retailer 406 may receive the carton 550 with the label 500 adhered thereto. The retailer 406, at step 632, may tear the tear strip 530t along the second lateral perforated border 524b and the third lateral perforated border 532b (see FIG. 20 and FIG. 14), and separate the outer label 520 from the fifth portion 510 along the first vertical perforated border 526b, the second vertical perforated border 528b, and the first lateral perforated border 522b (and along therewith, the first, second, third, and fourth portions 502, 504, 506, and 508 that are folded behind the outer label 520). The retailer 406 may then separate the first portion 502 (i.e., the inner label) from the second portion 504 along the first perforated border 512p, and the third portion 506 from the second portion 504 and the fourth portion 508 along the first line of weakness 5161 and the second lateral border 514p, respectively. The retailer 406 may verify that the shipping carton 550 contains all the valuable item(s) 18 listed on the label third portion 506, and if that is not the case, contact the customer 408 regarding any discrepancies.

At step 634, the retailer 406 may ship to the customer 408 at the customer's address some or all of the consumer goods 412 preselected by the customer 408. In this example, the retailer 406 may ship to the customer 408 the bicycle 412a and the television 412b. In so doing, the retailer 406 may use the label first portion 502 (i.e., the inner label) as a shipping label, as the first portion 502 may already have the name and address of the customer 408 printed thereon. The retailer 406 may not ship the laptop computer 412d also preselected by the customer 408 because its price (i.e., $400) exceeds the value (i.e., $300) of the valuable items 18a, 18b, and 18c of the customer 408. Had the value of the valuable items 18 exceeded the value of the consumer goods 412 selected by the customer 408, the retailer 406 may have included a check (or store credit voucher, coupon, et cetera) for the remainder with the consumer goods 412a and 412b. The method 600 may then end at step 636.

In some embodiments, the kiosk 400 may further include a customer database 407 (see FIG. 11). The kiosk 400 may utilize the customer database 407 to track all transactions made by all the customers 408 at one or more of the kiosks 400. The kiosk 400 (and specifically, the processor 103 in conjunction with the program 120B) may reward the customers 408 for regularly using the kiosk 400, pursuant to, for example, a loyalty program. For instance, the kiosk 400 may reward a customer 408 who has made over ten transactions at the kiosk 400 with a kiosk gift voucher for $100. Alternatively, or in addition, the kiosk 400 may reward (with a gift card, for example) every customer 408 whose transactions exceed a set dollar amount.

As noted above, a customer 408 may trade his valuable items 18 with the valuable items 18 of another customer 408. To facilitate interaction between customers 408 via the kiosk 400, the kiosk 400 may also include a ratings system. Each customer 408 may be allowed to provide a rating for each customer 408 that they have interacted with. People or skill in the art will appreciate that in some embodiments, the retailer 406 may include multiple entities, and customers 408 may be allowed to provide a rating for each retailer 406 (based on, for example, the quality of the consumer goods 412 of the retailer 406 and/or the expediency of their shipping, et cetera).

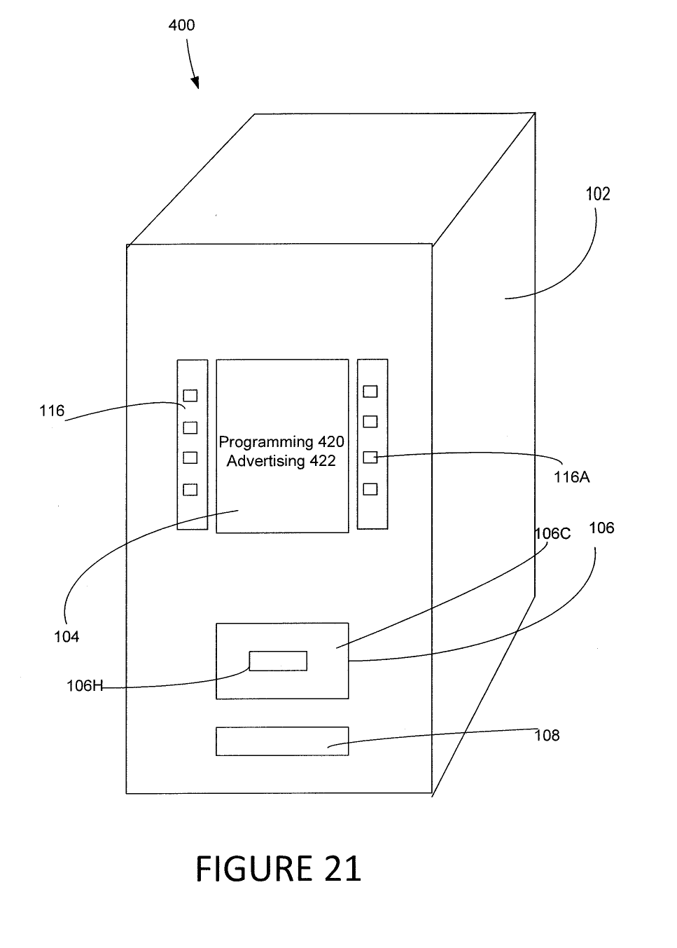

In some embodiments, a kiosk 400 that is not currently being used by a customer 408 may display on the output device 104 programming 420 (e.g., news, movies, television shows) and/or advertising 422 (e.g., special offers from all stores in a mall in which the kiosk 400 is located, or from one or more of the retailers 406) (see FIG. 21). Such functionality may generate an additional stream of revenue for the retailer 406 (or other operator of the kiosk 400) and serve to attract customers 408. In some embodiments, the kiosk 400 may display on the output device 104 valuable items 18 that have been deposited by customers 408 at other kiosks 400 to entice potential customers to purchase the same. Of course, the kiosk 400 may also display such programming 420 and/or advertising 422 while the method 600 is being performed, particularly in cases where the evaluation of the contents of the items 18 by the evaluating device 110 takes more than a set amount of time.

As can be appreciated, while the method 600 may allow the customer 408 to identify the consumer goods 412 (e.g., consumer goods 412a, 412b, 412c) that the customer 408 wishes to receive in return for her valuable items 18 (e.g., the gold bar 18a, the silver bracelet 18c, et cetera), these consumer goods 412 may not be shipped out by the retailer 406 to the customer 408 until after he has received the valuable items 18. Some customers may wish to receive remuneration for their valuable items 18 more promptly (e.g., within minutes of deposition of their valuable items 18 at the kiosk 400). Further, some customers 408 may wish to pawn their valuable items 18 instead. A method 800, discussed further below, may cater to such customers.

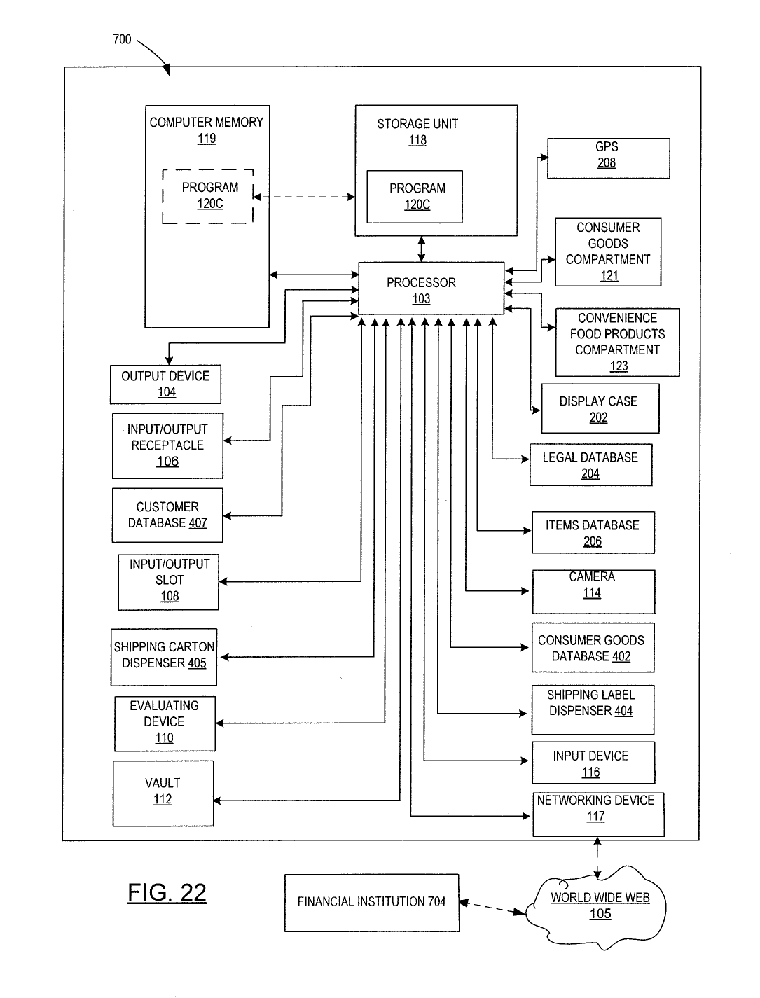

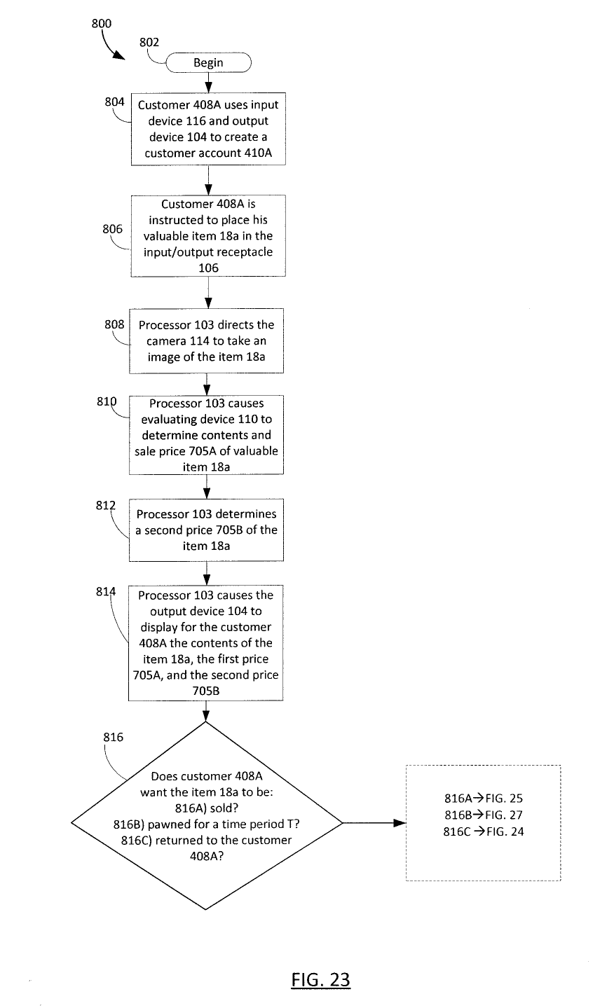

Attention is directed now to FIG. 22, which shows an alternate embodiment 700 of the kiosk that is substantially similar to the embodiment 400, except as specifically noted and/or shown, or as would be inherent. Further, those skilled in the art will appreciate that the embodiment 400 (and thus the embodiment 700) may be modified in various ways, such as through incorporating all or part of the disclosure provided herein. For uniformity and brevity, corresponding reference numbers may be used to indicate corresponding parts, though with any noted deviations.

One of the main differences between the system 400 and the system 700 may be that a program 120C housed in the storage unit 118 may include programming that is distinct from the program 120B of the system 400. As with other embodiments, the program 120C may be used to effectuate one or more of the steps outlined below. It will be apparent to those skilled in the art that the program 120C may in some embodiments incorporate the functionality of the other programs disclosed herein (e.g., the program 120, the program 120A, the program 120B, et cetera).

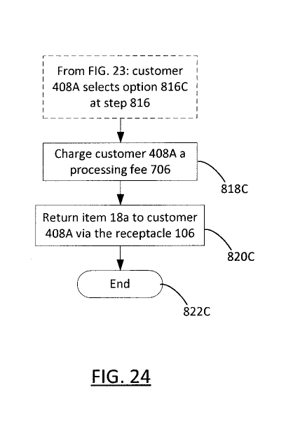

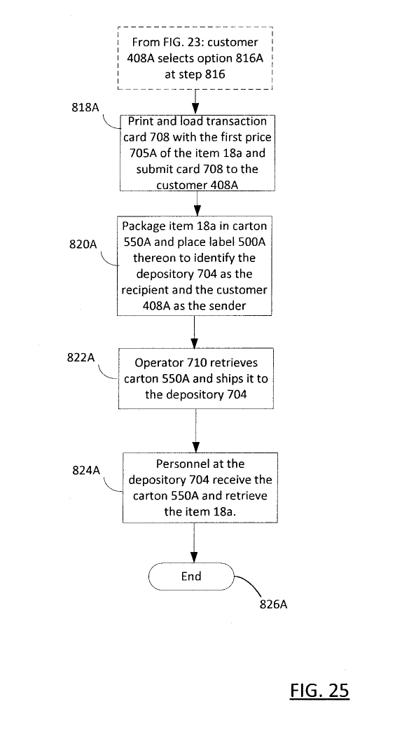

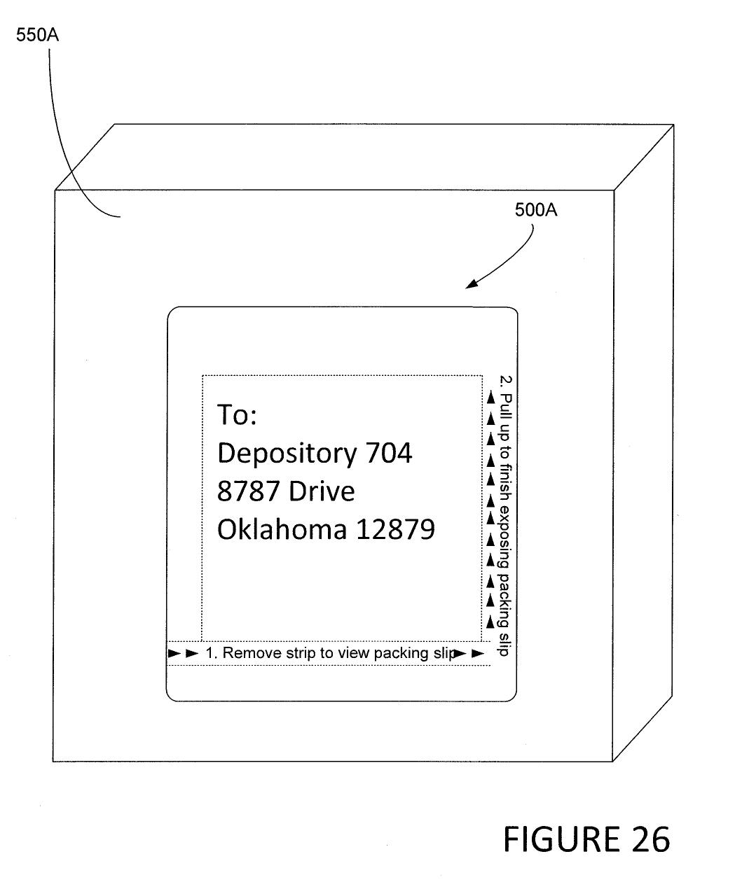

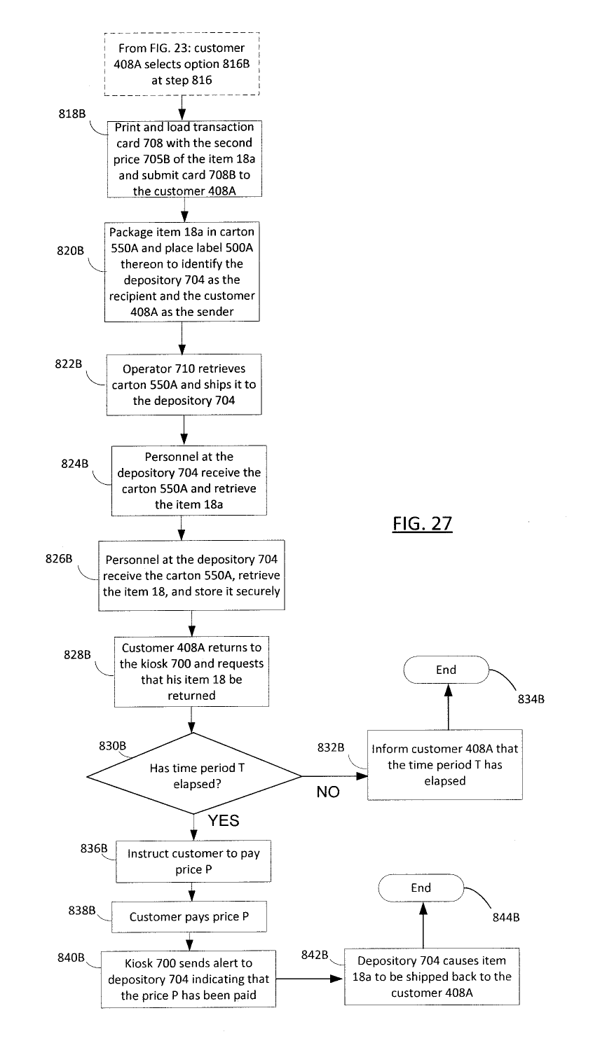

FIG. 23 shows a flowchart illustrating the method 800. The method 800 may begin at step 802, and at step 804, a customer 408A may approach the kiosk 700 and use the input device 116 and/or the output device 104 to open a customer account 410A. The customer account 410A may be managed by or be affiliated with a financial institution (or precious metals' depository) 704. As discussed in further detail below, the institution (or depository) 704 may stock the valuable items 18 received from the customers (e.g., the customer 408A) in a secure warehouse or elsewhere. The depository 104, may, for example, be government owned (e.g., the United States Bullion Depository in Fort Knox, Ky.), a private depository 104 (e.g., the First State Depository Company, LLC in Wilmington, Del.), or a private pawn shop.

In some embodiments, the financial institution or depository 704 may own one or more of the kiosks 700 and place these kiosks 700 at convenient (and preferably high-traffic) locations across the country. In other embodiments, the financial institution 704 may enter into an agreement with an owner or operator of the kiosk 700 and approve the kiosk 700 as a verified mechanism to evaluate the contents and price of the valuable items 18 on behalf of the institution 704. Irrespective of the mechanism utilized, it will be appreciated that the financial institution 704 may in some embodiments be bound to pay (or cause to be paid to) the customer 408A the price (or a percentage of the price) of the valuable item 18 as determined by the system 700.

The customer 408A may be required to enter his name and contact information into the kiosk 700 (using for example input device 116 and/or the output device 104) to set up the account 410A at step 804. In some embodiments, for verification, the customer 408A may be required to furnish his driver's license or other identification (using e.g., the receptacle 106 or the slot 108) before the account 410A may be set up. In these embodiments, the camera 114 may capture an image of the driver's license, and use facial recognition or other means (e.g., iris or fingerprint scanning) to obtain additional and unalterable information about the customer 408A.

At step 806, the processor 103 (using, e.g., the program 120C) may display on the output device 104 instructions for instructing the customer 408A to place his valuable item 18 (e.g., one or more of the gold bar 18a, the diamond necklace 18b, the silver bracelet 18c, et cetera) in the input/output receptacle 106. Assume for this example that the customer 408A places the gold bar 18a in the receptacle 106 for evaluation. Of course, one or more other valuable items 18 may similarly have been placed in the receptacle 106 by the customer 408A. At step 808, the processor 103 may cause the camera 114 to take an image of the item 18a, and in some embodiments, as discussed above, the item 18a may be moved from the receptacle 106 to the vault 112 to ensure that the customer 408A or another person may not improperly retrieve the item 18.

At step 810, the processor 103, using the program 120C, may cause the evaluating device 110 to determine the constituents and the sale price of the valuable item 18a. As outlined above, in making these determinations, the processor 103 may take into account the geographical location of the kiosk 700 and the current price of the constituents of the item 18a in that location. Assume for the purposes of this example that a sale price (herein the “first price”) 705A of the gold bar 18a is determined by the system 700 to be $100.

At step 812, the processor 103 may determine a pawn price (herein the “second price”) 705B of the item. The second price 705B may be a percentage of the first price 705A. For example, the second price 705B may be 80% (or another percentage, such as 70%, 60%, 90%, et cetera) of the first price 705A. In this example, assume that the second price 705B is 80% of the first price 705A (i.e., $80).

At step 814, the processor 103 may display the first price 705A and the second price 705B of the item 18a on the output device 104 for the customer 408A, along with the constituents of the item 18a. At step 816, the processor 103 may instruct the customer 408A to select one of options 816A, 816B, and 816C. Selection of the option 816A by the customer 408A may indicate to the kiosk 700 that the customer 408A wishes to sell the item 18a. Selection of the option 816B by the customer 408A may indicate to the kiosk 700 that the customer 408A wishes to pawn the item 18a. And, selection of the option 816C may indicate to the kiosk 700 that the customer 408A wishes for the item 18a to be returned to him forthwith.

Assume first that the customer 408A, at step 816, selects option 816C (FIG. 24) and requests that the item 18a be returned to him. At step 818C, the customer 408A may be charged a processing fee 706 at step 818C (e.g., $5, $10, et cetera), and at step 820C, the item 18a may be returned to the customer 408A (e.g., by placing the item 18a in the input/output receptacle 106) to end the method 800 at step 822C.

Assume now that the customer 408A wishes to sell the item 18a and at step 816, chooses option 816A (FIG. 25). At step 818A, the kiosk 700 may cause a transaction card 708 to be printed (e.g., using the output device 104), loaded with the first price 705A of the item 18a (i.e., $100 in this example), and submitted to the customer 408A via the slot 108.

The transaction card 708 may comprise one or more cards, and may be any card that the customer 408A can subsequently use to make purchases. In some embodiments, the transaction card 708 may be a debit card, which the customer 408A may be able to use to make any and all purchases. In other embodiments, the transaction card 708 may be a gift card; for example, if the kiosk 700 is placed within a retail location (e.g., a shopping mall), the transaction card 708 may be a mall gift card that the customer 408A must use within the mall. As can be appreciated, in these embodiments, the transaction card 708 may incentivize the customer 408A to shop at the mall (or another specific retail location). In other embodiments still, the transaction card 708 may comprise a debit card and a gift card; for example, the transaction card 708 may comprise a $80 debit card and a $20 gift card. While not required, as discussed with respect to the method 141 above, different transaction cards 708 associated with different entities (e.g., stores 1, 2, 3, et cetera) and having different values (e.g., $110, $115, $120, et cetera) may also be presented to the customer 408A so that the customer 408A can select the transaction card 708 that best fits his needs. The customer 408A may retrieve the transaction card 708 and, in this manner, be compensated for the item 18a while he is at the kiosk 700. In some embodiments, the processor 103 may cause the funds (i.e., the $100 in this example) to be electronically credited to the account 410A of the customer 408A instead of the transaction card 708 (e.g., using PayPal® or other such mechanisms), particularly where the customer 408A had set up the account 410A at a previous visit to the kiosk 700. In these embodiments, the customer 408A may be allowed to return to the kiosk 700 at any time and cause the kiosk 700 to provide to him the transaction card 708; for example, if the customer 408A had accumulated $300 in his account 410A in three prior visits to the kiosk 700 (e.g., by selling one item 18a at each visit), the customer 408A may obtain a transaction card 708A that consolidates the funds from each of these visits in the card 708.

At step 820A, the kiosk 700 may allow for the item 18a to be packaged (as discussed above) for shipping to the financial institution or depository 704. In some embodiments, the processor 103 may automatically cause the item 18a to be packaged in a shipping carton 550A (which may be similar to the shipping carton 550, see FIG. 19) and place thereon a fold-under label 500A (which may be similar to the label 500) (see FIG. 26). As with the other embodiments discussed above, the processor 103 may select a suitably sized carton 550A for the item 18A and print indicia on the shipping label 500A (e.g., using the output device 104 or another printer) that identifies the depository (or financial institution) 704 as the recipient of the carton 550A and the customer 408A as the sender. The carton 550 may thereafter be placed in the kiosk 700 by the customer 408A (e.g., the customer 408A may place the item in the receptacle 106, and the kiosk 700 may thereafter cause it to be stored in the vault 112).

At step 822A, an operator 710 of the kiosk 700 may retrieve the carton 550A from the kiosk 700 (e.g., the vault 112) and cause it to be shipped to the depository 704 (using e.g., USPS, FedEx, or another postal service). The kiosk 700 may verify the identity of the operator 710 before dispensing the carton 550A to him. For example, the operator 710 may be required to sign into an operator account at the kiosk 700, and in some embodiments, the kiosk 700 may use facial recognition, retina scanning, et cetera, to ensure that the carton 550A is being dispensed to an authorized person. Once personnel at the depository 704 receive the carton 550A at step 824A, they may tear the tear strip and retrieve the item 18a as discussed above with respect to the other embodiments. The method 800 may end at step 826A. The depository 704 may subsequently sell the item 18a in line with the applicable laws 350, or retain the item 18a for a period of time in its reserves.

Returning back to step 816 at FIG. 23, assume now that the customer 408A selects option 816B (FIG. 27) and indicates that he wants to pawn the item 18a for a time period T. The time period T may be any time period, such as a month, three months, a year, five years, et cetera. Assume that in this example, the customer 408A decides to pawn his item 18a for a time period T of three months.

At step 818B, the kiosk 700 may cause a transaction card 708B to be printed (e.g., using the output device 104), loaded this time with the second price 705B of the item 18 (i.e., $80 in this example), and submitted to the customer 408A via the slot 108. The customer 408A may utilize the transaction card 708B as he sees fit. Of course, in some embodiments, the transaction card 708B may also comprise gift cards as discussed above.

Steps 820B, 822B, and 824B may be generally identical to steps 820A, 822A, and 824A, respectively. Specifically, at step 820B, the kiosk 700 may cause the item 18a to be packaged and labeled, and at step 822B, the operator 710 of the kiosk 700 may ship the carton 550A to the depository 704. At step 824B, personnel at the depository may receive the carton 550A and retrieve the item 18a. And, at step 826B, personnel at the depository 704 may securely store the item 18 (e.g., in a policed warehouse or other facility).

At step 828B, the customer 408A may revisit the kiosk 700 and request (e.g., after signing into his account 410A) that his item 18a be returned to him. At step 830B, the processor 103 may check whether the time period T has elapsed. If the time period T (i.e., three months in this example) has elapsed since the item 18a was deposited in the kiosk 700 by the customer 408A, the kiosk 700 may inform the customer 408A at step 832B that the time period T has elapsed and that the item 18a may no longer be relinquished to him. The method 800 may then end at step 834B. In some embodiments, however, where the item 18a is still in the possession of the depository 704 after the time period T has elapsed, the customer 408A may be allowed to pay an extra fee for return of the item 18a (as discussed below).

If at step 830B the processor 103 determines that the time period T has not elapsed, the processor 103 may at step 836B instruct the customer 408A to pay a price P so that the item 18a may be returned to the customer. The price P may be greater than the second price 705B which the kiosk 700 paid to the customer 408a in return for the item 18a, and may, in some embodiments, be greater than the first price 705A. For example, the price P may include the second price 705B plus an additional fee for storage of the item 18a and the processing and handling of the transaction. Assume, in this example, that the price P is $110. At step 838B, the customer 408A may cause the price P to be paid to the kiosk 700; for example, the customer 408A may insert a debit card, a credit card, cash, et cetera, in the input/output slot 108 to allow the price P to be paid. In some embodiments, the customer 408A may be allowed to pay some or all of the price P by relinquishing another valuable item 18 (e.g., the item 18b) at the kiosk 700; that is, in these embodiments, the kiosk 700 may evaluate the contents and price of the valuable item 18b and apply its value towards payment of the price P for the item 18a.

Assume that the customer pays the price P (i.e., $110) using a debit card at step 838B, which card may be authenticated using methods known in the art. The kiosk 700 may alert the depository 704 (e.g., over the web 105) at step 840B that the price P has been paid by the customer 408A who wishes for his item 18a to be returned to him. At step 842B, personnel at the depository 704 may send (e.g., via a shipping company, a courier company, et cetera) the item 18a back to the customer 18a. While not required, the depository 704 may use the first portion 502 of the label 500A (which may include the name and address of the customer 408A as discussed above with respect to other embodiments) so that an additional shipping label is not needed when the item 18a is shipped back to the customer 408A. The method 800 may then end at step 844B.

People of skill in the art will appreciate that once the item 18a has been shipped to the depository 704 by the customer 408A, that the remaining steps may also be performed by the customer 408A at a computer at his residence or elsewhere; for example, in some embodiments, the customer 408, after he has deposited the item 18a at the kiosk 700, may use the website 105W or another website to request the return of his item 18a and pay the price P remotely (e.g., via PayPal). At least in some instances, however, it may be preferable to cause the customer 408A to return to the kiosk 700 as described herein so as to increase traffic at the location at which the kiosk 700 is situated.

While not expressly shown in the figures, in some embodiments, the customer 408A may be allowed to pay a fee only for the safeguarding of the item. 18a. For example, where the customer 408A does not wish to sell or pawn the item 18a, he may be allowed to pay a storage fee so that the item 18 may be safely stored at the depository 704 at the behalf of the customer 408A. In these embodiments, the kiosk 700 may function akin to a safety deposit box at a bank, and the item 18a may be shipped back to the customer 408A by the depository 704 at the behest of the customer 408A. Of course, the kiosk 700 may be superior to the bank in some respects; for example, the kiosk 700 may be operational after normal business hours (e.g., 24/7), may not require that a minimum balance be maintained before a safety deposit box is issued, et cetera.

Thus, as has been described, the system 700 may allow the customer 408A to: (1) determine the contents and market value of his valuable item 18a based on current market data; (2) sell the item 18a; (3) pawn the item 18a; and (4) securely store the item 18a in the depository 704.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A system located in one of a first area and a second area; the system configured to appraise and retain an item physically received from a seller and to thereafter sell the item to a buyer; the item having at least one constituent selected from the group consisting of a precious stone, a semi-precious stone, a precious metal, and a semi-precious metal; the system comprising:
a transaction point computer configured to appraise the item; wherein appraising the item includes:
(1) determining a composition of the item using an evaluating device; and
(2) associating an exchange value with the item using data obtained by the evaluating device and market data obtained over a network;
a networking device;
a legal database for storing a first set of rules and a second set of rules; the first set of rules governing the sale of the item in the first area; the second set of rules governing the sale of the item in the second area; and
a global positioning device for determining a location of the system;
wherein the computer includes machine readable instructions to ensure that the sale of the item to the buyer is in compliance with the first set of rules when the location is the first area and the second set of rules when the location is the second area.

2. The system of claim 1 wherein the first set of rules includes a first holding requirement.

3. The system of claim 2 wherein the first holding requirement dictates that the item be retained for a fixed number of days after it is received from the seller and before it is sold to the buyer.

4. The system of claim 3 wherein the second set of rules prohibits the sale of the item to a minor.

5. The system of claim 3 wherein the computer is configured to dispense a certificate to the seller upon the reception of the item.

6. The system of claim 5 wherein the certificate includes an image of the item and an item code associated with the item.

7. The system of claim 6 wherein the item code is configured to enable the seller to track the exchange value of the item on a day to day basis.

8. The system of claim 3 further comprising a vault for retaining the item for the fixed number of days.

9. The system of claim 8 wherein the computer is configured to cause the item to be shifted from the vault to a display case after the fixed number of days have passed.

10. A system located in one of a first area and a second area; the system configured to appraise and retain an item physically received from a seller and to thereafter sell the item to a buyer; the item having at least one constituent selected from the group consisting of a precious stone, a semi-precious stone, a precious metal, and a semi-precious metal; the system comprising:
a transaction point computer configured to appraise the item; wherein appraising the item includes:
(1) determining a composition of the item using an evaluating device; and
(2) associating an exchange value with the item using data obtained by the evaluating device and market data obtained over a network;
a networking device;
a legal database for storing a first set of rules and a second set of rules; the first set of rules governing the sale of the item in the first area; the second set of rules governing the sale of the item in the second area;
a global positioning device for determining a location of the system;
a vault for retaining the item; and
a display case for displaying the item;
wherein the computer includes machine readable instructions to ensure that the sale of the item to the buyer is in compliance with the first set of rules when the location is the first area and the second set of rules when the location is the second area.

11. The system of claim 10 further comprising a camera to capture an image of the seller.

12. The system of claim 11 wherein the evaluating device comprises an X-ray fluorescence tester.

13. The system of claim 12 wherein the first set of rules includes a first holding requirement dictating that the item be retained for a fixed number of days after it is received from the seller and before it is sold to the buyer.

14. The system of claim 13 wherein the computer is configured to dispense a certificate to the seller after reception of the item.

15. The system of claim 14 wherein the certificate includes an item code for tracking the exchange value.

16. A computer implemented method for appraising and selling an item; the item having at least one constituent selected from the group consisting of a precious stone, a semi-precious stone, a precious metal, and a semi-precious metal; the method comprising steps:
using a kiosk to physically receive the item from a seller;
appraising the item within the kiosk; wherein appraising the item includes:
(1) determining a composition of the item using an evaluating device; and
(2) associating an exchange value with the item using data obtained by the evaluating device and market data obtained over a network;
using a global positioning device to determine a location of the kiosk;
using a legal database stored in a non-transitory memory to ascertain a set of rules governing the sale of the item in the location; the set of rules comprising a holding requirement; the holding requirement dictating that the item be retained for a fixed number of days after it is received from the seller and before it is sold to a buyer;
allowing the buyer to purchase the item at the kiosk in compliance with the set of rules after the fixed number of days have elapsed.

17. The method of claim 16 further comprising the step of using the kiosk to dispense a certificate to the seller after reception of the item.

18. The method of claim 17 wherein the certificate includes an item code for enabling the seller to track the exchange value.

19. The method of claim 18 further comprising the step of using a camera in the kiosk to capture an image of the seller.

20. The method of claim 19 wherein the legal database includes a second set of rules governing the sale of the item in a second location.
